(19) United States
(12) Patent Application Publication
(10) Pub. No.: US 2005/0246731 A1
(43) Pub. Date: Nov. 3, 2005

(54) Writing apparatus and detecting device

(75) Inventors: Kenichi Tamura, Kanagawa (JP); Tooru Kuronuma, Kanagawa (JP)

Correspondence Address: WOLF GREENFIELD & SACKS, PC;FEDERAL RESERVE PLAZA, 600 ATLANTIC AVENUE, BOSTON, MA, 02210-2211, US

(73) Assignee: Sony Corporation, Tokyo (JP)

(21) Appl. No.: 11/087,087

(22) Filed: Mar. 22, 2005

(30) Foreign Application Priority Data
Mar. 22, 2004 (JP) P2004-082567
May 20, 2004 (JP) P2004-150553

(51) Int. Cl. G11B 23/03

(52) U.S. Cl. 720/729

(57) ABSTRACT

A cartridge has at least two detection holes. When both the detection holes are opened, a pushing element inside a hole-detecting unit is retained at a highest position by the biasing force of a biasing element so as to be remote from a detecting switch by a predetermined distance. Thus, the switch is off, and a disc is write-protected. When either of the detection holes is closed, respective projections of the pushing element are pushed by the closed detection holes such that the pushing element comes into contact with the detecting switch. Thus, the switch is turned on, and the disc is writable.

### BACKGROUND OF THE INVENTION

1. Field of the Invention

The present invention relates to writing apparatuses compatible with recording media in the form of, for example, a disc contained in a cartridge, and relates to detecting devices attached to writing apparatuses.

2. Description of the Related Art

Recently, a variety of recording media has been developed, and the expansion of the storage capacity has also been underway by writing data in high density. In conjunction with the further development in new recording media, the compatibility with the old-type recording media must be maintained. Consequently, a variety of recording media are in widespread use as recording media that belong to one category.

As an example, Mini Disc® (MDs) that are in widespread use at present will now be described. The MDs were first developed for audio application. At this time, a playback-only MD and a readable-writable MD were available. The playback-only MD is a disc in which all the data is written in embossed pits on the disc, and the readable-writable MD is a disc in which users can record music and the like by a magnetic-field modulation recording using a magneto-optical disc. After these MDs, a format referred to as MD-DATA was developed for reading and writing not only audio data but also other data used in, for example, computers. Furthermore, highly densified MDs (referred to as Hi-MDs) that can deal with more general data have recently been developed. Among these new Hi-MDs, newer discs are still being developed.

These discs belong to the category of the MD system, and are contained in a cartridge having an approximately same shape and size. These discs are loadable in reading-writing apparatuses (disc drives) compatible with the MDs. However, even if the disc drives are compatible with the MD system, there are still old-type disc drives that are only compatible with old-type discs. Although new-type discs are loadable into the old-type disc drives, the disc drives cannot write data to the new-type discs in the new format. Moreover, operational errors or damage to data may occur. Accordingly, when various discs are loaded in disc drives developed in different periods, at least problems such as the operational errors and the damage to the data must be avoided.

Therefore, the disc drives must be capable of determining the disc type of the various discs belonging to the same category. Known techniques for determining the disc type are disclosed in, for example, Japanese Unexamined Patent Application Publication Nos. 5-144165 and 8-321129. Furthermore, problems of the old-type disc drives to the new-type discs must be avoided. In particular, the management of the writability (protection against accidental erasure) of the discs is important in consideration of the compatibility of the old-type disc drives. For example, in the category of the MD system, the cartridge has a detection hole for setting the writability. Users can open or close the detection hole by operating a slider provided on the cartridge so as to set the writability of the disc. The determination of the writability by the detection hole is described in, for example, Japanese Unexamined Patent Application Publication Nos. 8-96552, 5-36234, and 5-144165.

To avoid the above-described problems, the new-type discs with which the old-type disc drives are not compatible must be write-protected in the old-type disc drives. However, when the writability of the new-type discs is always set to “write-protected” in the old-type disc drives by the detection hole, the detection hole cannot be used in determining the writability in the new-type disc drives. Accordingly, an additional detection hole for determining the writability is required. However, the known disc drives have only one detecting unit such as a switch to one detection hole. Thus, the additional detection hole also requires a dedicated detecting unit in the disc drives. This can lead to an increase in costs, and can inhibit a reduction in size and thickness of the drives.

### SUMMARY OF THE INVENTION

Accordingly, it is an object of the present invention to provide a detecting device capable of determining the writability of various recording media from a plurality of detection holes, and a writing apparatus including the detecting device.

The writing apparatus according to the present invention includes a body for loading a recording medium, a detecting device having first and second projections inside the body, and a controller for determining the type of the recording medium loaded in the body on the basis of the states of the first and the second projections of the detecting device and for performing a process depending on the type of the recording medium. The controller preferably performs a predetermined process to the recording medium when the first or the second projection is pushed.

Moreover, the controller preferably determines the type of the recording medium loaded in the body on the basis of the states of the first and the second projections of the detecting device, and preferably determines the recording medium as writable when the first or the second projection is pushed. Yet moreover, the body preferably includes a mechanical deck having first and second holes from which the first and the second projections protrude; the detecting device preferably includes a detecting switch disposed on the bottom face of the body, a pushing element having an approximate Y-shape formed of the first and the second projections and a contact portion for coming into contact with the detecting switch, and a biasing element for biasing the pushing element to a predetermined position such that the first and the second projections protrude from the first and the second holes; the contact portion is preferably separate from the detecting switch when the pushing element is at the predetermined position, and the contact portion is preferably in contact with the detecting switch when the first or the second projection of the pushing element is pushed by the loaded recording medium; and the controller preferably determines the type of the recording medium on the basis of the contact state of the contact portion and the detecting switch, and preferably performs the process depending on the type of the recording medium.

Furthermore, the controller preferably determines the writability of the loaded recording medium on the basis of the contact state of the contact portion and the detecting switch.

Also, the controller preferably determines the type of the recording medium of the loaded recording medium on the basis of a signal based on a light beam reflected from the loaded recording medium and the states of the first and the second projections, and preferably performs the process depending on the type of the recording medium.

The detecting device for detecting the on-off state of a switch according to the present invention includes a supporting body having a plurality of holes, a detecting switch disposed at a predetermined position inside the supporting body, a pushing element including a plurality of projections protruding from the respective holes and a contact portion for coming into contact with the detecting switch, and a biasing element for biasing the pushing element to a predetermined position such that the projections protrude from the respective holes. The detecting device is characterized in that the contact portion is separate from the detecting switch when the pushing element is at the predetermined position, and the contact portion is in contact with the detecting switch when at least one of the projections of the pushing element is pushed.

The protruding lengths of the projections preferably differ from each other.

According to the present invention, the plurality of projections, for example, the first and the second projections, are provided as one detecting device. The projections (the pushing elements) are pushed when the plurality of detection holes in the recording medium are closed or are not present, or are not pushed when the plurality of detection holes are opened or are present. The writability to the recording medium is determined on the basis of the states of the projections.

### BRIEF DESCRIPTION OF THE DRAWINGS

FIG. 1 is an exploded perspective view of a reading-writing apparatus according to an embodiment of the present invention;

FIGS. 2A, 2B, 2C, and 2D are a top view, a side view, a front view, and a circuit diagram of a hole-detecting section according to the embodiment, respectively;

FIGS. 3A and 3B illustrate the structure of the hole-detecting section according to the embodiment;

FIG. 4 is a block diagram illustrating the structure of the reading-writing apparatus according to the embodiment;

FIGS. 5A and 5B illustrate the specifications of discs according to the embodiment;

FIG. 6 is block diagram of a storage unit of the reading-writing apparatus according to the embodiment;

FIG. 7 illustrates detection holes of a playback-only MD;

FIG. 8 illustrates the detection holes of a playback-only high-density MD;

FIGS. 9A and 9B illustrate the detection holes of a readable-writable MD and a high-density MD type A;

FIGS. 10A and 10B illustrate the detection holes of high-density MDs types B and C according to the embodiment;

FIG. 11 illustrates the relationship between disc types and factors for determining the disc types according to the embodiment;

FIGS. 12A, 12B, and 12C illustrate area structures of the playback-only MD, the playback-only high-density MD, and the high-density MD type A, respectively;

FIGS. 13A, 13B, and 13C illustrate the area structures of the high-density MD type B, the playback-only high-density MD, and the high-density MD type C, respectively;

FIG. 14 illustrates P-TOC of the MDs;

FIG. 15 illustrates U-TOC of the MDs;

FIG. 16 is a flow chart of a method for determining the disc type according to the embodiment;

FIGS. 17A and 17B illustrate detection hole modes according to the embodiment;

FIGS. 18A to 18C illustrate operations of the hole-detecting unit depending on the detection hole modes according to the embodiment;

FIGS. 19A, 19B, 19C, 19D, and 19E are a top view, a side view, a front view, a bottom view, and a circuit diagram, respectively, of a hole-detecting unit according to another embodiment.

FIGS. 20A and 20B illustrate the structure of the hole-detecting unit according to the embodiment;

FIGS. 21A to 21E illustrate a disc cartridge of the high-density MDs types B and C;

FIGS. 22A to 22D illustrate an opening-closing mechanism of the detection holes of the high-density MDs types B and C;

FIGS. 23A to 23E illustrate the opening-closing mechanism of the detection holes of the high-density MDs types B and C; and

FIGS. 24A to 24D illustrate the relationship between a reference plane and the states of the detection holes of the high-density MDs types B and C.

### DESCRIPTION OF THE PREFERRED EMBODIMENTS

According to embodiments of the present invention, a recording medium and a disc drive in the category of the MD system will now be described. Descriptions will be provided in the following order:
1. Structure of reading-writing apparatus (disc drive)
2. Structure of hole-detecting unit
3. Structure of disc drive
4. Disc type
5. Structure of storage unit
6. Detection holes of cartridge
7. Determination of disc type
8. Process for determining writability
9. Structures of other hole-detecting units
10. Setting of protruding length of hole-detecting unit
   1. Structure of Reading-Writing Apparatus (Disc Drive)

A disc drive according to an embodiment of the present invention is a reading-writing apparatus compatible with a disc of the MD system, the MD being a magneto-optical disc of a magnetic-field modulation recording type. The disc drive can write in higher density and is not only compatible with the widespread MDs for music but also with other high-density discs available for storing various data such as video data and other data used in computers.

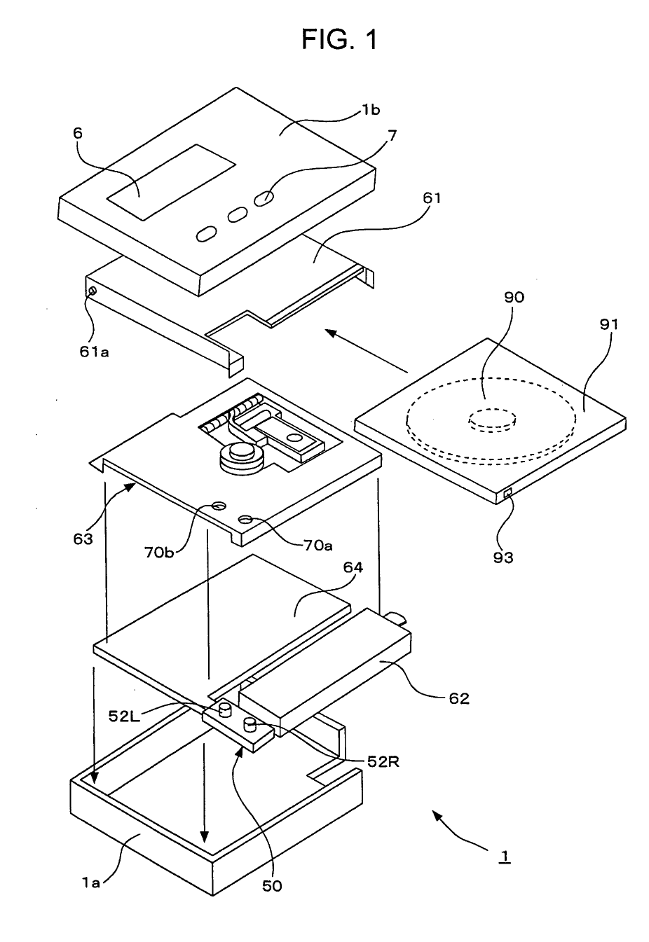

FIG. 1 is an exploded perspective view of the reading-writing apparatus according to the embodiment of the present invention. A reading-writing apparatus 1 in FIG. 1 includes a cabinet 1a and a cover 1b attached to the cabinet 1a so as to be openable and closable by a supporting shaft. The cover 1b is opened when a disc 90 is loaded or unloaded. A display 6 for displaying an operating state, a mode state, and the like, and operating buttons functioning as an operating unit 7 for users are provided on the outer face of the cover 1b. Although not shown, input-output terminals such as analog input-output terminals or universal serial bus (USB) terminals for input-output processing are provided on the side faces of the cabinet 1a or the cover 1b.

The reading-writing apparatus 1 includes a holder 61, a mechanism (a mechanical deck) 63, a rectangular printed board 64, a battery 62, and the like. An inner end 61a of the holder 61 is pivoted on the mechanism 63 such that the holder 61 is rotatable. The disc 90 contained in a cartridge 91 is loaded in the holder 61. The printed board 64 is attached to the mechanism 63.

The mechanism 63 accesses the disc 90. The mechanism 63 includes a turntable rotating the disc 90, a spindle motor driving the turntable, an optical pickup, and a sliding mechanism transferring the optical pickup. The battery 62 opposes the mechanism 63, and is disposed so as not to overlap the optical pickup for reading the disc 90. For example, the battery 62 is disposed along the side of the printed board 64 adjacent to a loading slot of the cartridge 91.

The cartridge 91 contains the disc 90 functioning as a recording medium therein, and includes a slider 93 for setting the writability of data to the disc 90 (described below). Users can open or close detection holes by this slider 93.

A hole-detecting unit 50 for protecting against accidental erasure of data in the disc 90 is attached to the printed board 64. The hole-detecting unit 50 will be described below. Determination holes 70a and 70b are disposed at positions opposing projections 52R and 52L protruding from the hole-detecting unit 50. When the mechanism 63 is superposed on the printed board 64, the projections 52R and 52L protrude from the determination holes 70a and 70b. Moreover, the determination holes 70a and 70b are disposed so as to oppose detection holes on the cartridge 91 while the disc is loaded. As a result, the projections 52R and 52L protrude from the determination holes 70a and 70b, and are fitted into (or, when the detection holes are closed, the projections 52R and 52L come into contact with) the detection holes on the cartridge 91. The opened or closed state of the detection holes is then determined by the pressure applied to the projections 52R and 52L when the closed detection holes are closed or not present.

2. Structure of Hole-Detecting Unit

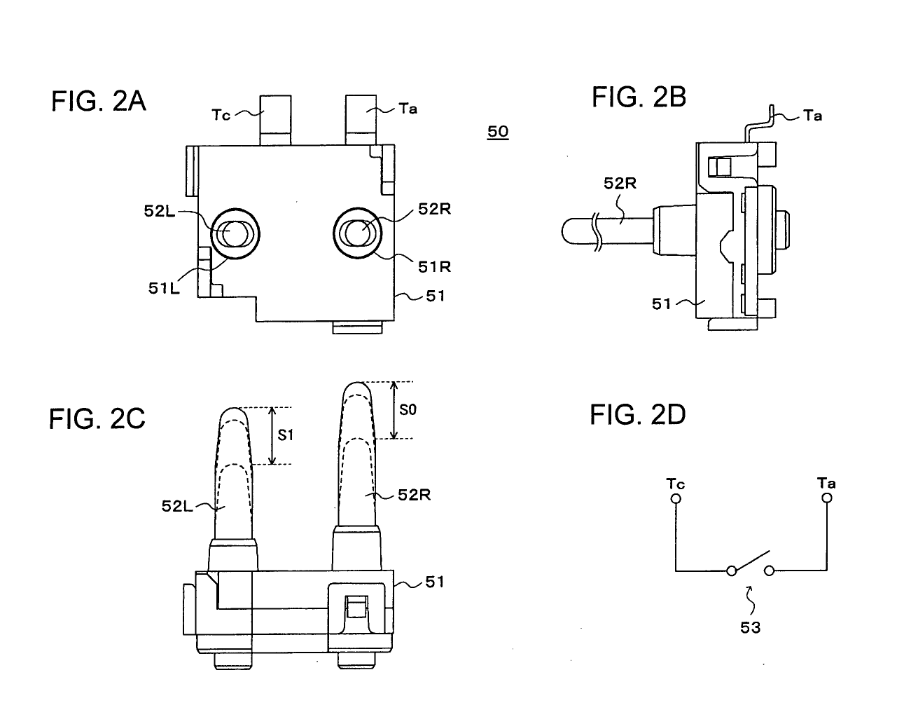

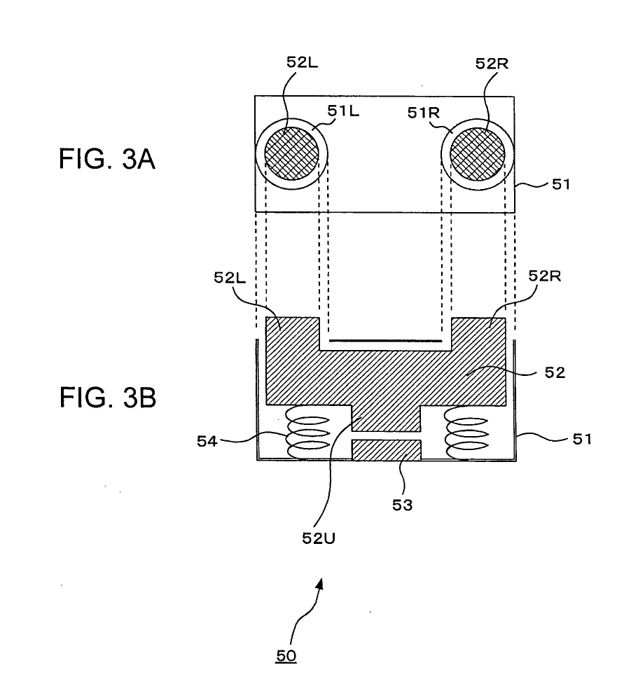

The structure of the hole-detecting unit 50 according to the embodiment will now be described in detail with reference to FIGS. 2A to 3B. FIGS. 2A, 2B, and 2C are a top view, a side view, and a front view of the hole-detecting unit 50, respectively; and FIG. 2D is a circuit diagram of the hole-detecting unit 50. FIGS. 3A and 3B are schematic views illustrating the inner structure of the hole-detecting unit 50 shown from the top and the side, respectively.

The hole-detecting unit 50 includes a guide 51, a pushing element 52, a detecting switch 53, and biasing elements 54. The guide 51 is an approximately cuboid casing having approximately circular holes 51R and 51L provided at a predetermined spacing along the longitudinal direction on the top face of the guide 51. The guide 51 further includes the detecting switch 53 on the inner bottom face thereof. Although the shape of the casing according to the embodiment is cuboid, any other shapes may be employed as long as the hole-detecting unit can function unhindered.

The pushing element 52 having an approximate Y-shape is provided in the guide 51. The pushing element 52 includes the projections 52R and 52L protruding from the holes 51R and 51L in the upper part, and a contact portion 52U disposed so as to come into contact with the detecting switch 53 in the lower part. Although the shapes of the holes 51R and 51L and those of the projections 52R and 52L according to the embodiment are circular, any other shapes such as triangles and rectangles may be employed as long as the hole-detecting unit can function well.

The biasing elements 54 such as coiled springs are disposed under the pushing element 52 so as to support the pushing element 52 from the bottom. The pushing element 52 is retained at a standstill in the air, i.e. at a predetermined position where the projections 52R and 52L protrude from the holes 51R and 51L to a highest position, by the biasing force of these biasing elements 54. At this time, the contact portion 52U of the pushing element 52 is remote from the detecting switch 53 by a predetermined distance. Although the two biasing elements 54 support the pushing element 52 in the drawing, other biasing elements may be disposed so as to surround the contact portion 52U and the detecting switch 53. That is to say, any other biasing elements may be employed wherever the pushing element 52 can perform a predetermined operation.

The detecting switch 53 determines the writability. When the detecting switch 53 comes into contact with the contact portion 52U or is pushed by the contact portion 52U, in other words, when the pushing element 52 moves downward from the predetermined position, the switch in the circuit shown in FIG. 2D is turned on. On the contrary, when the detecting switch 53 is remote from the contact portion 52U by the predetermined distance, in other words, when the pushing element 52 is at the predetermined position, the switch is turned off. The writability is determined by the state of the detecting switch 53. In this embodiment, a disc is writable when the detecting switch 53 is on, and is write-protected when the detecting switch 53 is off. Also, the two signals (on and off) of the switch may be reversely used for the determination.

The detecting switch 53 includes a contact point disposed on the top face thereof for coming into contact with the contact portion 52U, and is led to terminals Ta and Tc connected to external circuitry as shown in a circuit in FIG. 2D. The terminals Ta and Tc are disposed outside the guide 51 as shown in FIG. 2A, and connected at a predetermined position of the printed board 64 shown in FIG. 1. The on-state or the off-state of the circuit shown in FIG. 2D is determined by the potentials of the terminals Ta and Tc by a storage controller (described below).

The hole-detecting unit 50 having the above-described structure operates as follows:

When the projection 52R or 52L protruding from the hole 51R or 51L is pushed by a predetermined force, the biasing elements 54 shrink and the pushing element 52 moves downward from the predetermined position. Then, the contact portion 52U of the pushing element 52 comes into contact with or pushes the detecting switch 53, and thus the switch is turned on. The information that the switch is turned on is output from the terminals Ta and Tc. When the force pushing the projection 52R or 52L is removed, the pushing element 52 moves upward by the biasing force of the biasing elements 54, and returns to the predetermined position. Accordingly, the detecting switch 53 separates from the contact portion 52U by the predetermined distance, and the switch is turned off. The information that the switch is turned off is then output from the terminals Ta and Tc.

With reference to FIG. 2C, the protruding lengths of the projections 52R and 52L are different. The projection 52R can be pushed within a range S0, and the projection 52L can be pushed within a range S1. The reason why the protruding lengths of the projections 52R and 52L are different will be described below.

3. Structure of Disc Drive

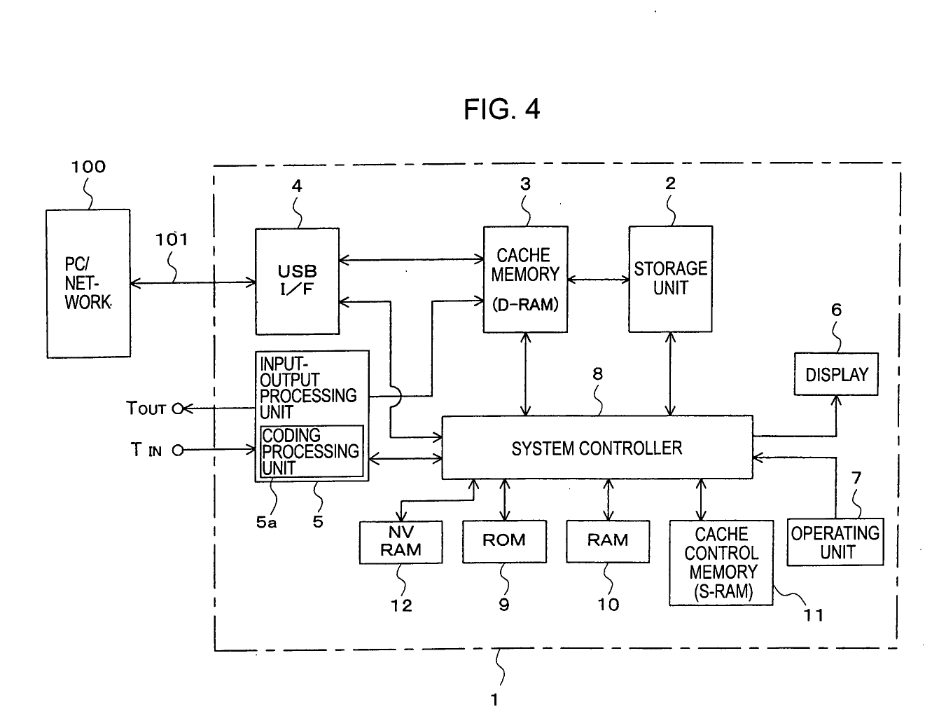

The structure of the reading-writing apparatus according to the embodiment will now be described with reference to FIG. 4. In FIG. 4, the reading-writing apparatus 1 can transmit data to external equipment such as a personal computer (or a network) 100. The reading-writing apparatus 1 includes a storage unit 2, a cache memory 3, a USB interface 4, an input-output processing unit 5, the display 6, the operating unit 7, a system controller 8, a read-only memory (ROM) 9, a random-access memory (RAM) 10, a cache control memory 11, and a non-volatile random-access memory (NV-RAM) 12. The storage unit 2 reads from or writes to a disc loaded therein. The hole-detecting unit 50 according to the embodiment of the present invention is also controlled by this storage unit 2. The structure of the storage unit 2 will be described below.

The cache memory 3 is composed of, for example, a dynamic random access memory (D-RAM), and buffers data read from the disc by the storage unit 2 or data to be written in the disc by the storage unit 2. Reading and writing of data to the cache memory 3 are controlled by tasks activated in the system controller 8, i.e. a central processing unit (CPU).

The USB interface 4, for example, transmits data to the personal computer 100 through a USB cable 101. The input-output processing unit 5 inputs and outputs read and written data when the reading-writing apparatus 1 functions as, for example, a single audio apparatus.

The system controller 8 entirely controls the reading-writing apparatus 1, and also controls the communication between the reading-writing apparatus 1 and the connected personal computer. The ROM 9 stores operating programs, fixed parameters, and the like of the system controller 8. The RAM 10 functions as a working area for the system controller 8, and also functions as a storing area for various types of required information.

The cache control memory 11 is composed of, for example, a static random access memory (S-RAM), and stores information for controlling the state of the cache memory 3. The system controller 8 controls data caching with reference to the cache control memory 11. The NV-RAM 12 functions as a storing area for retaining data during the power is turned off.

The display 6 displays various types of information for users on the basis of the control of the system controller 8. The information includes an operating state, a mode state, information such as a title of music, a track number, and time, and the like. The operating unit 7 includes operating buttons such as operating keys or jog dials for user operations. Users can operate the operating unit 7 to issue instructions for reading, writing, and data transmission. The system controller 8 carries out predetermined controls on the basis of the operating information input from the operating unit 7.

The structure of the reading-writing apparatus 1 shown in FIG. 4 is an example, and an input-output processing system compatible not only with audio data but also with video data may be provided in the input-output processing unit 5. Also, the connection between the reading-writing apparatus 1 and the personal computer 100 is not limited to via USB, and may be via other external interface standards such as IEEE 1394.

4. Disc Type

Discs of the MD system are used as recording media in the reading-writing apparatus 1 according to the embodiment. The reading-writing apparatus 1 is compatible not only with the above-described MDs for music, but also with high-density discs available for storing various data such as data used in computers. First, discs that belong to the category of the MD system and that are loadable to the reading-writing apparatus 1 according to the embodiment will now be described.

For the sake of identification, terms such as a “playback-only MD”, a “readable-writable MD”, a “high-density MD type A”, a “high-density MD type B”, a “playback-only high-density MD”, and a “high-density MD type C” are used for a variety of MDs. These terms are used for the descriptions in this specification. These discs are described as follows:

The playback-only MD is generally referred to as a premastered disc for playback-only audio application. All the data is written in embossed pits. The readable-writable MD is a magneto-optical disc of a magnetic-field modulation recording type that can read and write data for audio application. The playback-only MD and the readable-writable MD are so-called first-generation MDs, and are in widespread use as audio MDs at present. After the first-generation MDs, a “MD-DATA” was developed for storing general data for expanding the audio application. The MD-DATA is categorized as the readable-writable MD or the playback-only MD in this specification.

After that, next-generation MDs that are highly densified in accordance with the MD system have been developed. These are the “high-density MDs”. The high-density MDs herein are also referred to as “Hi-MDs”, and are available for data storage application for general purposes. The Hi-MDs achieve more than double storage capacity compared with that of the first-generation MDs. The high-density MDs have evolved, and several types of MDs exist at present. The MDs are referred to as a “high-density MD type A”, a “high-density MD type B”, and a “high-density MD type C” described as above. The high-density MD type A is referred to as a “Hi-MD 1”. The high-density MD type B is referred to as a “Hi-MD 1.5”. The high-density MD type C is referred to as a “Hi-MD 3”. Another type of the high-density MD type B (Hi-MD 1.5) for playback-only application through the use of embossed pits has also been designed. The MD is referred to as a “playback-only high-density MD” for distinguishing from the high-density MD type B.

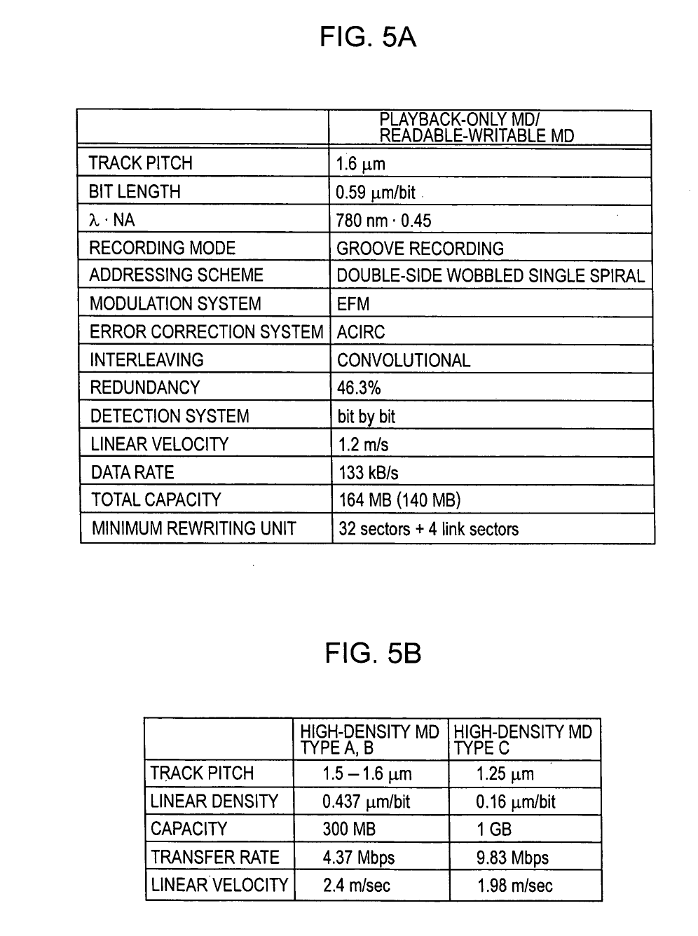

FIGS. 5A and 5B are the specifications of the first-generation MDs (the playback-only MD, and the readable-writable MD, including the MD-DATA), and those of the high-density MDs (the high-density MD type A, the high-density MD type B, the playback-only high-density MD, and the high-density MD type C) for comparison. As shown in FIG. 5A, for the first-generation MDs (and the MD-DATA), a track pitch is 1.6 μm, a bit length is 0.59 μm/bit, a laser wavelength λ is 780 nm, and an aperture ratio NA of an optical head is 0.45.

The readable-writable MD is of a groove recording type that uses grooves (grooves on the face of the disc) as tracks in reading and writing. A single-spiral groove (track) that is wobbled at both sides (a wobbled groove) so as to indicate address information is employed as an addressing scheme. The absolute address expressed by the wobbling is also referred to as an address in pre-groove (ADIP) in this specification. The playback-only MD has no grooves and has only tracks formed by embossed pit lines in which addresses and data are written.

These first-generation MDs employ eight-to-fourteen modulation (EFM) as a modulation system for writing data, and an advanced cross interleave Reed-Solomon code (ACIRC) as an error correction system. Data is interleaved in a convolutional code, and the data redundancy is 46.3%.

Data is detected bit-by-bit. A constant linear velocity (CLV) of 1.2 m/s is employed in a disk-driving scheme. The standard data rate during reading and writing is 133 kB/s, and the storage capacity is 164 MB (140 MB for MD-DATA). A cluster is a minimum data unit for rewriting data, and includes thirty-six sectors composed of thirty-two main sectors and four link sectors.

On the other hand, there are two standards for the high-density MDs at present, i.e. a standard for the high-density MDs types A and B (including the playback-only high-density MD), and that for the high-density MD type C with higher density.

First, for the high-density MDs type A and B, the track pitch is 1.5 to 1.6 μm, a linear density is 0.437 μm/bit, and the storage capacity reaches 300 MB. In addition, a transfer rate at the standard speed is 4.37 Mbps, and the linear velocity is 2.4 m/s. For the high-density MD type C, the track pitch is 1.25 μm, the linear density is 0.16 μm/bit, and the storage capacity reaches 1 GB. In addition, the transfer rate at the standard speed is 9.83 Mbps, and the linear velocity is 1.98 m/s.

Although not shown in FIG. 5B, the high-density MDs employ an RLL (1, 7) PP method compatible with high-density writing as the modulation system for writing data, and a Reed-Solomon long distance code (RS-LDC) with a burst indicator subcode (BIS) having higher correction capability as the error correction system. Herein RLL represents “run length limited”, and PP represents “parity preserve/prohibit repeated minimum transition run-length (RMTR)”. Data is interleaved in a block code, and the data redundancy is 20.50%. Data is detected by Viterbi decoding using a PR (1, 2, 1) ML, where PR represents “partial response” and ML represents “maximum likelihood”. The techniques of the RLL (1, 7) modulation and the RS-LDC error correction system are disclosed in, for example, Japanese Unexamined Patent Application Publication No. 11-346154 and International Publication No. WO00/07300. The CLV or zone constant angular velocity (ZCAV) is employed in the disk-driving scheme.

5. Structure of Storage Unit

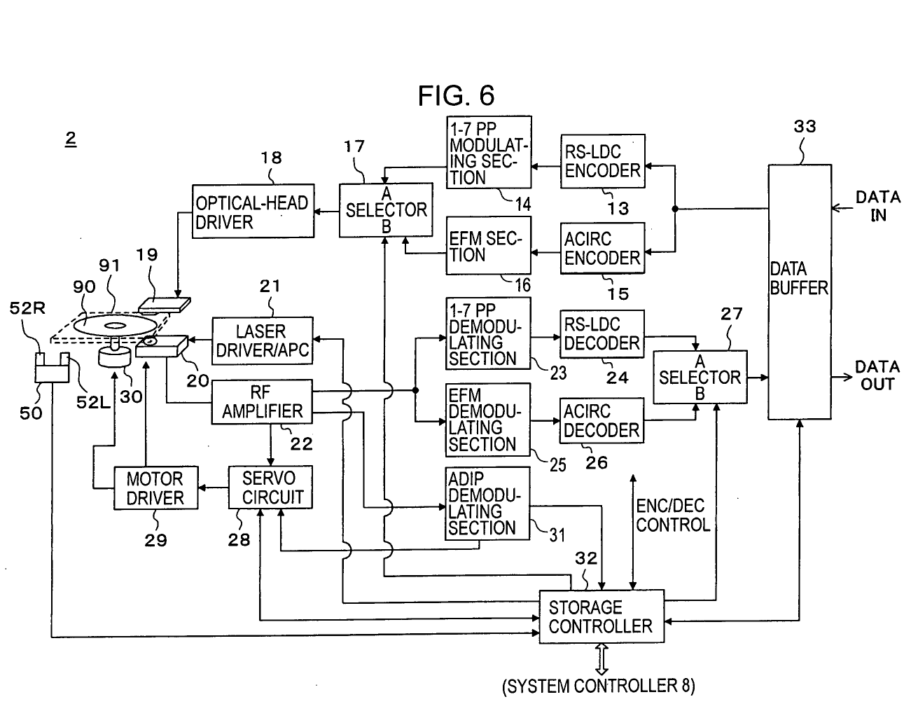

The storage unit 2 shown in FIG. 4 is a disc drive compatible with the above-described first-generation MDs and the high-density MDs as recording media for general purposes. FIG. 6 illustrates an exemplary structure of the storage unit 2.

The disc 90 shown in the drawing is a disc of the above-described types, and is contained in the cartridge 91. In the storage unit 2, the disc 90 is rotated by a spindle motor 30 by using the CLV scheme. A laser beam is radiated from an optical head 20 to the disc 90 during reading and writing. During writing, the optical head 20 outputs a high-level laser beam so as to heat a recording track to the Curie temperature. On the other hand, during reading, the optical head 20 outputs a relatively low-level laser beam so as to detect data from the reflected beam by the magnetic Kerr effect. Therefore, although not shown in the drawing in detail, the optical head 20 includes a laser diode functioning as means for outputting laser; an optical system including a polarizing beam splitter, an object lens, and the like; and a photodetector for detecting the reflected beam. The objective lens included in the optical head 20 may be retained by a biaxial mechanism so as to be movable in the radial direction of the disc and in a direction in which the object lens comes into contact with or separates from the disc.

Moreover, a magnetic head 19 opposes the optical head 20 with the disc 90 interposed therebetween. The magnetic head 19 applies the magnetic field modulated by the written data to the disc 90. Furthermore, although not shown, a sled motor and a sled mechanism are provided in the storage unit 2 so as to move the entire optical head 20 and the magnetic head 19 in the radial direction of the disc.

The storage unit 2 includes not only the optical head 20, the reading-writing head system by the magnetic head 19, and the disc-rotating system by the spindle motor 30 but also a writing system, a reading system, a servo system, and the like. The writing system includes a first modulating section (EFM, ACIRC encoding) for writing to the first-generation MDs, and a second modulating section (RLL (1, 7) PP modulation, RS-LDC encoding) for writing to the high-density MDs. The reading system includes a first demodulating section (EFM demodulation, ACIRC decoding) for reading from the first-generation MDs (including user table of contents (U-TOC) in the high-density MDs), and a second demodulating section (RLL (1, 7) demodulation based on the data detection by the Viterbi decoding using PR (1, 2, 1) ML, RS-LDC decoding) for reading from the high-density MDs.

When a laser beam is radiated from the optical head 20 to the disc 90, information detected as the reflected beam from the disc 90 (a photocurrent obtained from the reflected laser beam by the photodetector) is input to a radio frequency (RF) amplifier 22. The RF amplifier 22 performs current-voltage conversion, amplification, and matrix operations to the detected information; and extracts a playback RF signal as playback information, a tracking error signal TE, a focus error signal FE, groove information (ADIP information expressed by the wobbling of the track on the disc 90), and the like.

For reading the first-generation MDs, the playback RF signal obtained at the RF amplifier 22 is processed at an EFM demodulating section 25 and an ACIRC decoder 26. That is to say, the playback RF signal is binarized to form an EFM signal line, and then EFM demodulated at the EFM demodulating section 25. Furthermore, error correction and de-interleaving are conducted to the signal at the ACIRC decoder 26. At this time, the signal is in the form of compressed data of an adaptive transform acoustic coding (ATRAC) format. Since a selector 27 is set at a B contact during reading the first-generation MDs, the demodulated ATRAC compressed data is output from the storage unit 2 through a data buffer 33 as playback data from the disc 90. The compressed data is sent to the cache memory 3 shown in FIG. 4.

In contrast, for reading the high-density MDs, the playback RF signal obtained at the RF amplifier 22 is processed at an RLL (1, 7) PP demodulating section 23 and an RS-LDC decoder 24. That is to say, the playback data in the form of an RLL (1, 7) coded line is obtained from the playback RF signal by data detection by the Viterbi decoding using PR (1, 2, 1) ML, and the RLL (1, 7) demodulation is performed on the RLL (1,7) coded line at the RLL (1, 7) PP demodulating section 23. Furthermore, error correction and de-interleaving are conducted to the data at the RS-LDC decoder 24. Since the selector 27 is set at an A contact during reading the high-density MDs, the demodulated data is output from the storage unit 2 through the data buffer 33 as the playback data from the disc 90. The demodulated data is sent to the cache memory 3 shown in FIG. 4.

The tracking error signal TE and the focus error signal FE output from the RF amplifier 22 is sent to a servo circuit 28, and the groove information is sent to an ADIP demodulating section 31.

The ADIP demodulating section 31 extracts wobbling components from the groove information by limiting a frequency band using a band-pass filter, performs frequency demodulation and bi-phase demodulation, and then extracts ADIP addresses. The extracted ADIP addresses, i.e. the absolute address information on the disc, are sent to a storage controller 32, i.e. a CPU. The storage controller 32 performs required control operations on the basis of the ADIP addresses. Furthermore, the groove information is sent to the servo circuit 28 for spindle servo control.

The servo circuit 28 generates a spindle error signal for CLV servo control on the basis of, for example, an error signal obtained by integrating phase errors between playback clocks (PLL clocks during decoding) of the groove information. Moreover, the servo circuit 28 generates various servo control signals (a tracking control signal, a focus control signal, a sled control signal, a spindle control signal, and the like) on the basis of the spindle error signal, the tracking error signal TE and the focus error signal FE sent from the RF amplifier 22, a track jump command from the storage controller 32, an access command, and the like; and outputs them to a motor driver 29. That is to say, the servo circuit 28 generates the servo control signals by performing required operations such as phase compensation, gain adjustment, and target setting to the above-described servo error signal or commands.

The motor driver 29 generates required servo drive signals on the basis of the servo control signals sent from the servo circuit 28. The servo drive signals herein include a biaxially driving signal for driving the biaxial mechanism (in the focusing direction, and in the tracking direction), a sled-motor driving signal for driving the sled mechanism, and a spindle-motor driving signal for driving the spindle motor 30. Thus, focusing control and tracking control for the disc 90 and CLV control for the spindle motor 30 are performed by these servo drive signals.

For writing to the disc 90, the cache memory 3 supplies data to the data buffer 33. Since a selector 17 is set at a B contact during writing to the first-generation MDs, an ACIRC encoder 15 and an EFM section 16 will function. In this case, interleaving and addition of error correction codes are conducted to the compressed data from the cache memory 3 (the compressed data processed at the input-output processing unit 5) at the ACIRC encoder 15, and then the data is EF modulated at the EFM section 16. The EF modulated data is sent to an optical-head driver 18 through the selector 17, and the magnetic head 19 applies the magnetic field depending on the EF modulated data to the disc 90 so as to write the data.

During writing to the high-density MDs, the selector 17 is set at an A contact. Therefore, an RS-LDC encoder 13 and an RLL (1, 7) PP modulating section 14 will function. In this case, interleaving and addition of error correction codes of an RS-LDC type are conducted to the high-density data from the cache memory 3 at the RS-LDC encoder 13, and then the data is RLL (1, 7) modulated at the RLL (1, 7) PP modulating section 14. Recording data in the form of an RLL (1, 7) coded line is sent to the optical-head driver 18 through the selector 17, and the magnetic head 19 applies the magnetic field depending on the modulated data to the disc 90 so as to write the data.

A laser driver/automatic laser power control (APC) 21 drives the laser diode to emit a laser beam during reading and writing, and also performs so-called APC operations. Although not shown, a detector for monitoring the laser power is provided in the optical head 20, and the monitoring signal is fed back to the laser driver/APC 21. The laser driver/APC 21 compares the current laser power obtained as the monitoring signal with the set laser power, and reflects the difference on the laser-driving signal. Thus, the laser power output from the laser diode can be stabilized at the set value. The storage controller 32 sets different laser power values for reading and writing to a register in the laser driver/APC 21.

The above-described operations (accessing, servo controls, data writing, data reading, and data transmission) are performed by the storage controller 32 on the basis of the instructions from the system controller 8.

Although described below, the cartridge 91 containing the disc 90 as an MD includes detection holes indicating the writability or the disc reflectance. In particular, the detection holes for the writability is openable and closable by users. The storage unit 2 includes the above-described hole-detecting unit 50 so as to detect such a state (open or close, or presence or absence) of the detection holes of the cartridge 91.

As shown in FIGS. 2 and 3, the hole-detecting unit 50 includes the projections 52R and 52L at positions opposing the two detection holes on the cartridge 91 while the disc is loaded. When the detection holes are open, the projections 52R and 52L enter the detection holes, and the contact portion 52U of the pushing element 52 shown in FIG. 3 does not come into contact with the detecting switch 53 (OFF). On the other hand, when the detection holes are closed (or do not exist), the projections 52R and 52L are pushed, and the contact portion 52U comes into contact with the detecting switch 53 (ON). This information on the state of the detecting switch 53 is sent to the storage controller 32, and thus the storage controller 32 recognizes the states of the detection holes.

In this embodiment, the storage controller 32 is provided in the storage unit 2. Also, the system controller 8 may directly control the sections in the storage unit 2.

6. Detection Holes of Cartridge

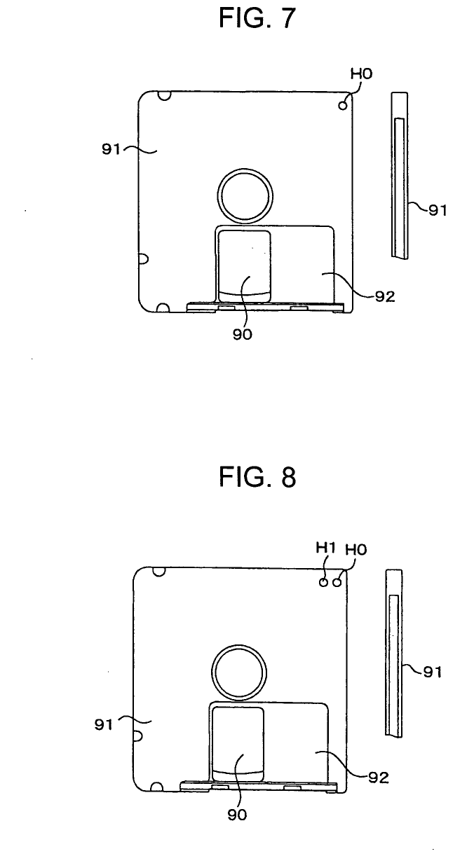

The detection holes provided in the cartridge 91 for the above-described discs will now be described. FIGS. 7 to 10 are bottom views and side views of the cartridge 91 for the various discs. In the case for discs in the category of the MD system shown in FIGS. 7 to 10, the disc 90 rotates in the flat cartridge 91. The cartridge 91 has a slidable shutter 92. When the shutter 92 is open as shown in the drawings, the interior of the disc 90 is exposed. The shutter 92 is normally closed to cover the disc 90, but is opened by the mechanism in the deck when the cartridge 91 is loaded in the disc drive.

FIG. 7 illustrates the cartridge 91 for the playback-only MD. The cartridge 91 of the playback-only MD has a detection hole H0 at a predetermined position adjacent to the bottom as shown in FIG. 7. The position of the detection hole H0 is used in determining the writability. When an open detection hole H0 exists, or when the detection hole H0 is open, the disc is write-protected. Since the playback-only MD is naturally write-protected, the cartridge only has a single hole as the detection hole H0, and does not have any mechanism for opening or closing the hole. Accordingly, no slider for opening and closing is provided on the side face or the like of the cartridge 91.

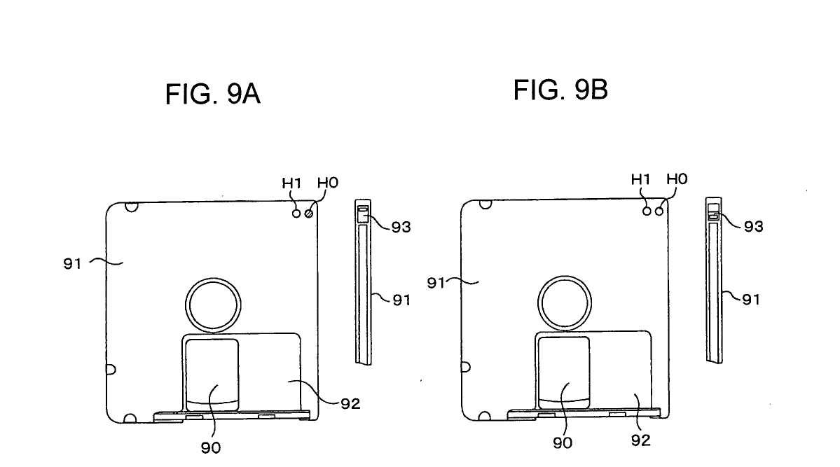

FIGS. 9A and 9B illustrate the cartridge 91 for the readable-writable MD and the high-density MD type A. In this case, the cartridge has detection holes H0 and H1. As in the case for the playback-only MD, the state of the detection hole H0 indicates the writability. In this case, the slider 93 provided to the cartridge can close (FIG. 9A) or open (FIG. 9B) the detection hole H0 by changing its position. In other words, users can operate the slider 93 to close or open the detection hole H0 as shown in FIG. 9A or 9B for setting the writability. The disc is write-protected when the detection hole H0 is open, whereas the disc is writable when the detection hole H0 is closed. Thus, as in the case for the detection hole H0 of the playback-only MD, the open detection hole H0 is defined as write-protected.

The second hole in FIGS. 9A and 9B, i.e. the detection hole Hi, is used in indicating the reflectance of the disc 90. The readable-writable MD and the high-density MD type A are magneto-optical discs, and the playback-only MD is an optical disc having embossed pits formed thereon. The magneto-optical disc has much lower reflectance than the optical disc. For example, the reflectance of the optical disc is approximately 70%, while that of the magneto-optical disc is approximately 15% to 30%. As a result, the internal signal-processing setting (for example, RF gains) of the disc drive (storage unit 2) must be changed depending on the disc type, and the detection hole H1 is formed for determining the disc type. When a detection hole H1 exists, or when the detection hole H1 is open, the reflectance of the disc is low. In this case, the detection hole H1 is fixed, and is not opened or closed by the slider 93. On the other hand, since the reflectance of the above-described playback-only MD is high, the detection hole Hi does not exist in the playback-only MD.

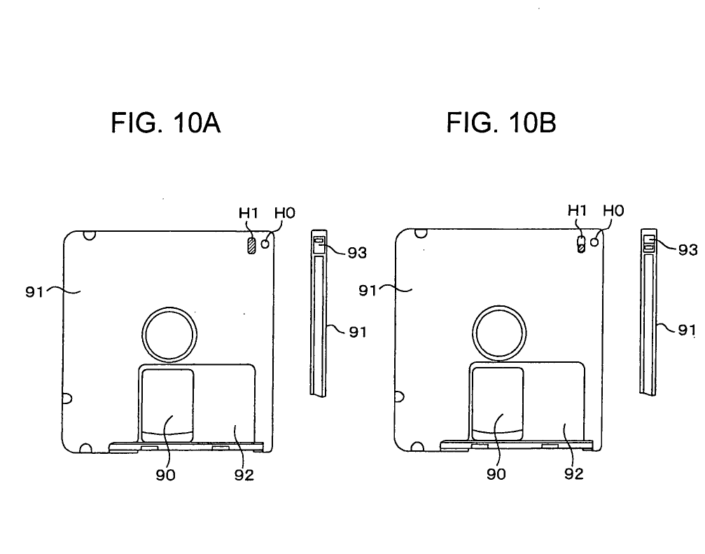

FIGS. 10A and 10B illustrate the cartridge 91 for the high-density MDs types B and C. As shown in the drawings, the cartridge has the detection holes H0 and H. The detection hole H1 is a slender slit in this embodiment, but may be a circle as in the case for FIGS. 9A and 9B. The detection hole H1 can be closed (FIG. 10A) or opened (FIG. 10B) by the slider 93. As is clear from the drawings, the operating direction of the slider 93 is the same as that in the readable-writable MD and the high-density MD type A shown in FIGS. 9A and 9B. In the case of the high-density MDs types B and C, the disc is writable when the detection hole H1 is closed (as shown in FIG. 10A), while the disc is write-protected when the detection hole H1 is open (as shown in FIG. 10B). In contrast, the detection hole H0 is kept open regardless of the position of the slider 93.

FIG. 8 illustrates the cartridge 91 for the playback-only high-density MD, which corresponds to an embossed-pit disc for the high-density MD type B. Both detection holes H0 and H1 are fixed and are always open. The detection hole H0 is always open as in the case for the high-density MDs types B and C shown in FIGS. 10A and 10B. The detection hole H1 is also fixed since the disc of the playback-only high-density MD shown in FIG. 8 is write-protected. That is to say, the disc shown in FIGS. 10A and 10B is write-protected when the detection hole H1 is opened, but the disc of the playback-only high-density MD shown in FIG. 8 has the detection hole H1, and is always write-protected.

When comparisons are made with the playback-only optical discs shown in FIGS. 7 and 8, the playback-only MD shown in FIG. 7 is write-protected by the detection hole HO (open state), and the playback-only high-density MD shown in FIG. 8 is write-protected by the detection hole H1 (open state).

Old-type disc drives compatible only with the first-generation MDs recognize the open state at the position of the detection hole H0 as “write-protected”. Due to the detection hole H0 formed in the high-density MDs types B and C shown in FIGS. 10A and 10B and the playback-only high-density MD shown in FIG. 8, the old-type disc drives recognize that the discs of these types are write-protected. Since the detection hole H0 is fixed to the open state in the high-density MDs types B and C, the detection hole H0 cannot be used to set the writability, the detection hole H1 is used to set the writability.

As described above, the definitions of the detection holes H0 and H1 are different in the case for the playback-only MD, the readable-writable MD, and the high-density MD type A; and in the case for the high-density MDs types B and C, and the playback-only high-density MD. Therefore, the disc drive capable of writing data to the high-density MDs types B and C cannot determine the writability merely from the states of the detection holes. Accordingly, the disc drive (storage unit 2) into which the various MDs are loaded detects the disc type and determines the meaning of the detection holes H0 and H1 depending on the disc type.

7. Determination of Disc Type

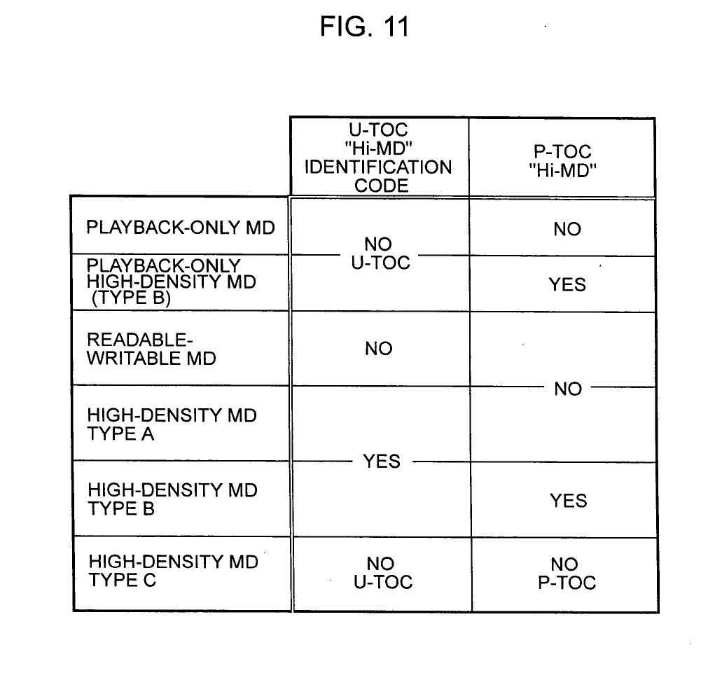

A method for determining the disc type (determining factors) will now be described. Operative examples of determination processes in which the determining factors are combined will be then described. FIG. 11 illustrates the relationship between the determining factors and the disc type.

It is known that the MD system has management information referred to as premastered table of contents (P-TOC) and the U-TOC at a position adjacent to the inner radius of the disc. Since this management information includes the disc type, the P-TOC and the U-TOC are used in determining the disc type.

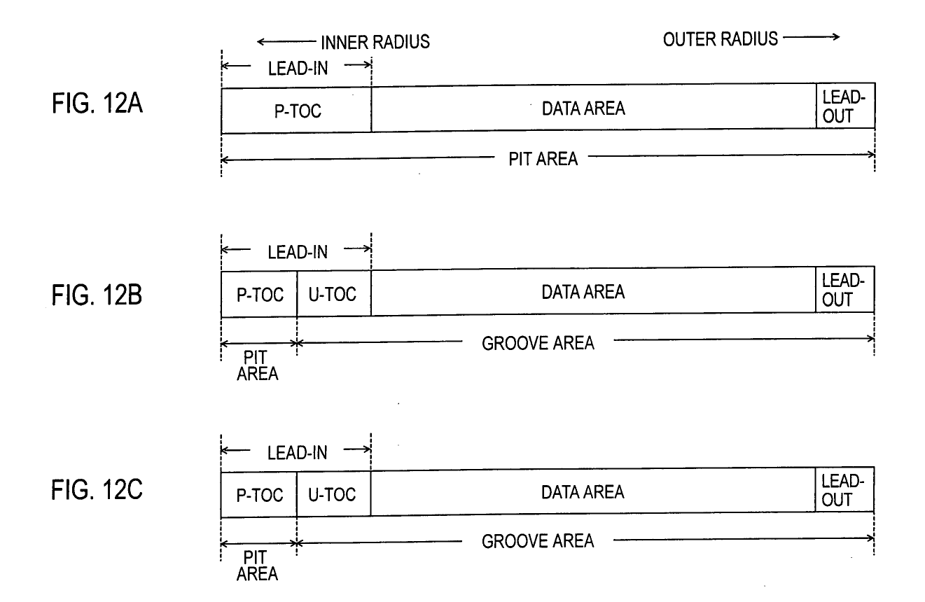

In advance of the method for determining the disc type by the management information, the area structure of the discs will now be described. FIG. 12A illustrates the area structure of the playback-only MD expressed as a strip-shaped region in the radial direction from the inner radius to the outer radius of the disc. As shown in the drawing, an area adjacent to the innermost radius of the disc is defined as a lead-in area, and the P-TOC is written in this area. The subsequent area is defined as a data area. Audio data is recorded in this data area by a track (a piece of music) beforehand. The addresses of the recorded tracks, the positions of the areas, and the like are managed by the P-TOC. An area adjacent to the outermost radius of the disc is defined as a lead-out area. For the playback-only MD, the entire region is a pit area in which data is written by embossed pits.

FIG. 12B illustrates the area structure of the readable-writable MD. In this case, the P-TOC and the U-TOC are written in the lead-in area adjacent to the inner radius. Users can record and replay audio tracks in the data area by themselves. For the readable-writable MD, only the region of the P-TOC in the lead-in area adjacent to the inner radius is the pit area for embossed pits. The region of the U-TOC, the data area, and the lead-out area are readable-writable groove areas by magneto-optical recording. The tracks recorded in the data area are managed by the U-TOC, and the U-TOC can be rewritten according to recording, deleting, or editing in the data area. The basic area positions and the like are managed by the P-TOC.

FIG. 12C illustrates the area structure of the high-density MD type A. As is clear from the drawings, the area structure is the same as that of the readable-writable MD. For region controls of the P-TOC and the U-TOC, various data files such as audio, video, or the like written in the data area are managed by the file allocation table (FAT) system.

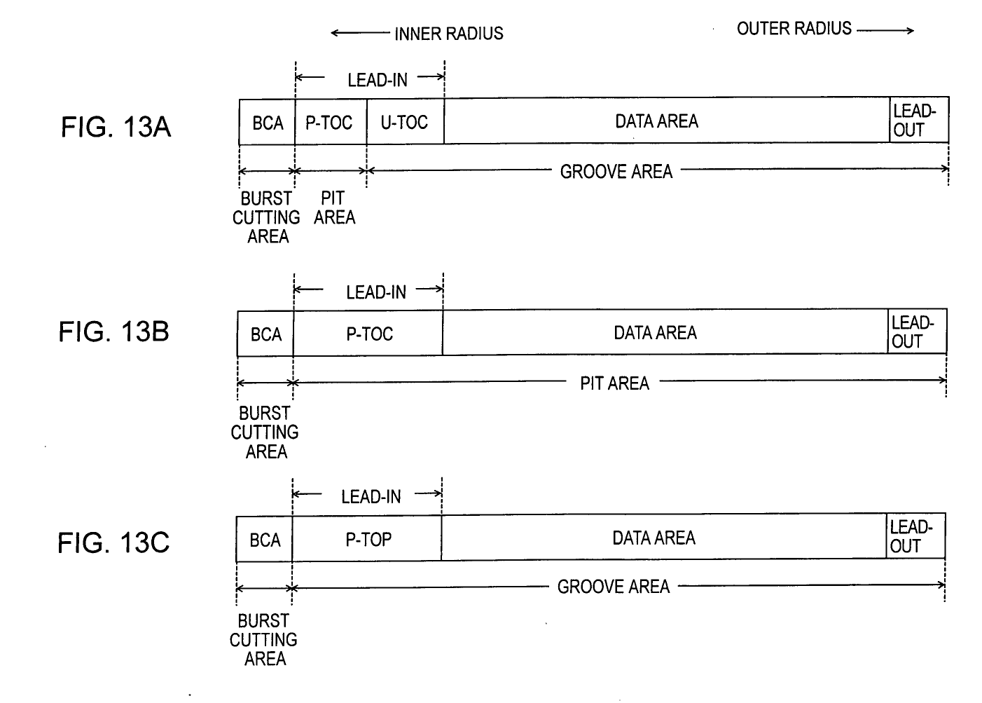

FIG. 13A illustrates the area structure of the high-density MD type B. In this case, the area adjacent to the innermost radius of the disc is defined as a burst cutting area (BCA). In this area, barcode-shaped patterns are radially formed so as to write predetermined IDs and the like. The subsequent area is the lead-in area in which the P-TOC and the U-TOC are written. The region of the P-TOC is the pit area for the embossed pits. The region of the U-TOC, the data area, and the lead-out area are the readable-writable groove areas. For the region controls of the P-TOC and the U-TOC, the data files written in the data area are also managed by the FAT system.

FIG. 13B illustrates the area structure of the playback-only high-density MD. This type corresponds to the high-density MD type B only for playback. Therefore, only the P-TOC is in the lead-in area, and the rest of the regions except for the BCA is the pit area.

FIG. 13C illustrates the area structure of the high-density MD type C. This type also has the BCA in the area adjacent to the innermost radius. Instead of the P-TOC and the U-TOC, management information referred to as premastered table of disc parameters (P-TOP) is written in the lead-in area. The lead-in area, the data area, and the lead-out area are defined as the groove areas.

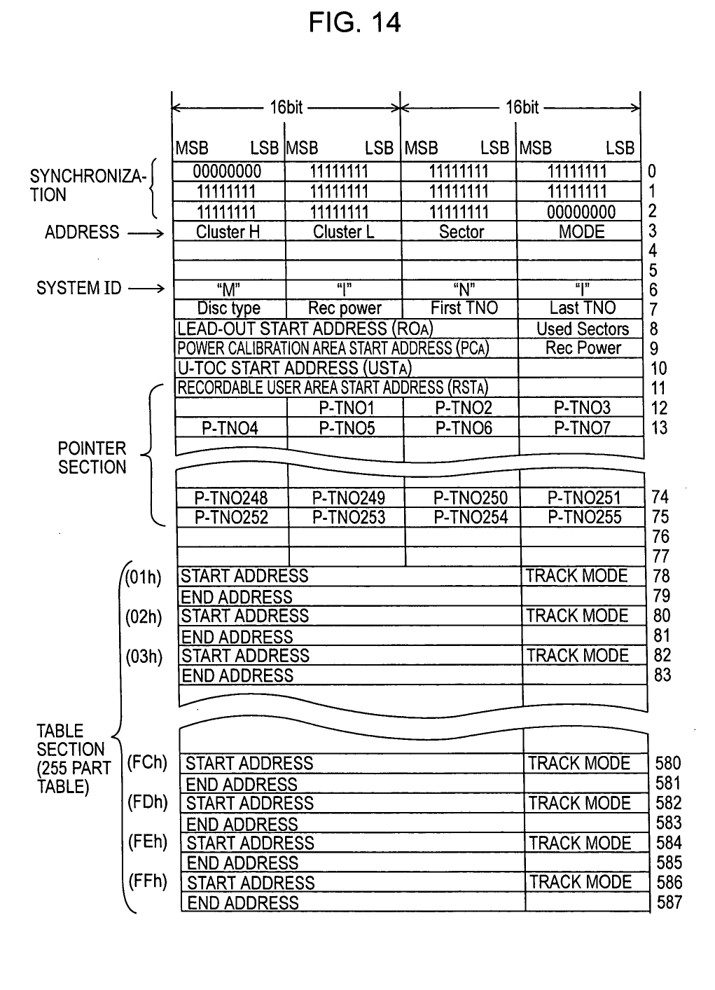

On the basis of the above-described area structures of the discs, the method for determining the disc type by the P-TOC and the U-TOC will now be described. First, determination by the P-TOC will be described. FIG. 14 illustrates the structure of a first sector (Sector 0) of a cluster of the P-TOC. The P-TOC Sector 0 includes synchronization patterns of 12 bytes at the head, and subsequently the own address of the sector (a cluster address, a sector address). These synchronization patterns and the address are common in all the sectors in the MD format.

The system ID is written in a predetermined byte position with 4 bytes. In addition, management information such as the area structure and the disc properties, namely, the disc type, writing power, the first track number, the final track number, the start address of the lead-out area, the start address of a power calibration area, the start address of the U-TOC, and the start address of the recordable user area are written. A pointer section and a table section are then written. The table section includes part tables where the start addresses and the end addresses of the tracks or mode information of the tracks are managed. The part tables are assigned by pointers (P-TNO1 to P-TNO-255) f the pointer section such that the tracks are managed. The pointers P-TNO1 to P-TNO255 correspond to the first track to the two hundred fifty-fifth track, respectively. In the case for the playback-only MD, the tracks are managed by the P-TOC. However, in the readable-writable MD, the tracks are managed by the pointer section and the table section of the U-TOC (described below).

In this P-TOC, the system ID is written as described above. For the first-generation MDs (the playback-only MD, and the readable-writable MD), a system ID of “MINI” is written in ASCII code. On the other hand, for the high-density MD type B, a system ID of a code indicating a high-density MD, for example, “HiMD” is written. Therefore, the disc type can be determined as shown in FIG. 11 according to the presence or the absence of the code “HiMD” indicating the high-density MDs in the system ID of the P-TOC.

In short, if the code “HiMD” does not exist, the disc is any one of the playback-only MD, the readable-writable MD, and the high-density MD type A. On the contrary, if the code “HiMD” exists, the disc is the high-density MD type B or the playback-only high-density MD. The high-density MD type C does not have the P-TOC as shown in FIG. 13C. If the P-TOC does not exist, the disc is then determined as the high-density MD type C.

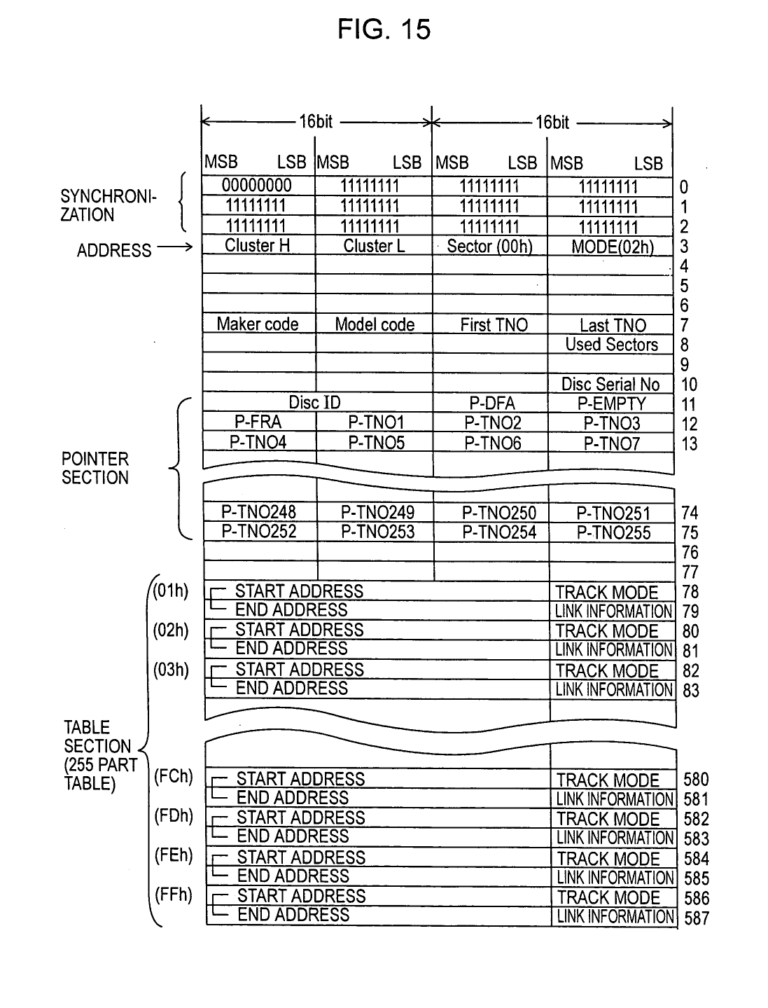

Next, determination by the U-TOC will now be described. FIG. 15 illustrates the structure of a first sector (Sector 0) of a cluster of the U-TOC. The U-TOC Sector 0 also includes the synchronization patterns of 12 bytes at the head, and subsequently the own address of the sector (a cluster address, a sector address). A maker code, a model code, the first track number, the final track number, used sectors in the U-TOC, the disc serial number, and the disc ID are written in a predetermined byte position. A pointer section and a table section are then written. The table section includes part tables where the start addresses and the end addresses of the tracks or mode information of the tracks are managed. The part tables are assigned by pointers (P-DFA, P-EMPTY, P-FRA, P-TNO1 to P-TN0255) of the pointer section such that the tracks are managed. The pointers P-TNO1 to P-TN0255 correspond to the first track to the two hundred fifty-fifth track, respectively. The pointer P-DFA manages a defective area on the disc. The pointer P-EMPTY manages part tables that are not in use. The pointer P-FRA manages unused regions (free areas) in the data area.

For the readable-writable MD, the tracks can be written, deleted, and edited. The U-TOC manages the track, and the pointer section and the part tables are rewritten according to recording, deleting, or editing of the tracks.

The above-described maker code is a code number assigned to manufacturers. For the high-density MDs types A and B, in particular, an identifier for a high-density MD format (Hi-MD format: the format for the high-density MDs types A and B shown in FIG. 5B) is written in the maker code area. Therefore, the disc type can be determined as shown in FIG. 11 according to the information of the maker code.

In short, if the code indicating the high-density MD format does not exist in the U-TOC, the disc is the readable-writable MD. On the contrary, if the code exists, the disc is the high-density MD type A or the high-density MD type B. The high-density MD type C does not have the U-TOC as shown in FIG. 13C. Also, the playback-only MD and the playback-only high-density MD do not have the U-TOC as shown in FIGS. 12A and 13B. Therefore, if the U-TOC does not exist, the disc is then any one of the high-density MD type C, the playback-only MD, and the playback-only high-density MD.

From these determining factors, the discs of six types in the category of the MD system (the playback-only MD, the readable-writable MD, the high-density MD type A, the high-density MD type B, the playback-only high-density MD, and the high-density MD type C) can be distinguished.

Although the type of the MD is determined by the management information in this embodiment, the type of the MD may be determined by other various methods. For example, from signals based on the reflected beams from the disc, the disc reflectance, the phase difference in the signals, the address structure of the recoding medium, and the like may be detected.

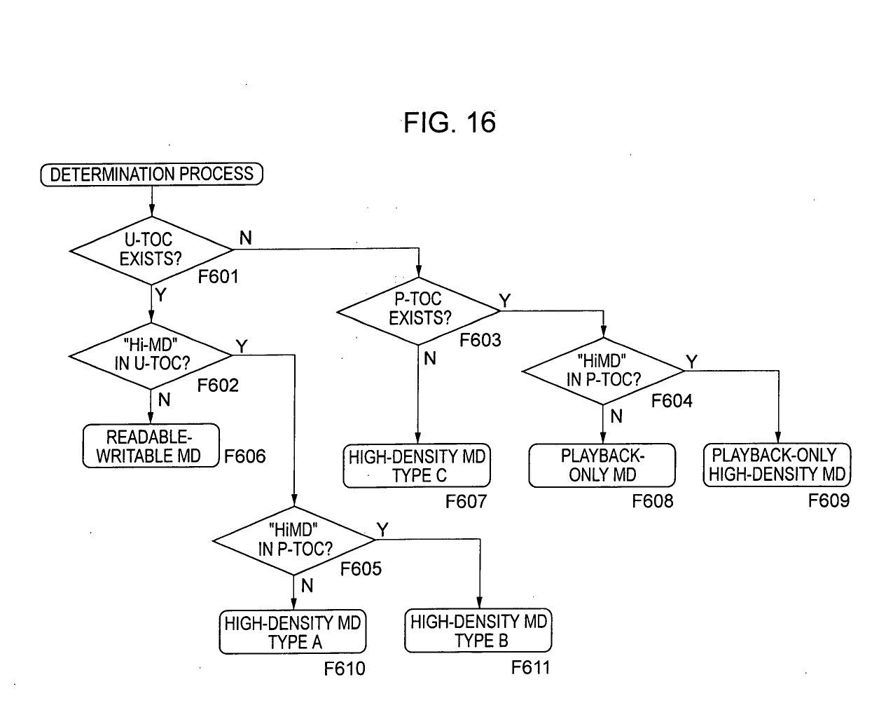

FIG. 16 illustrates processes in the method for determining the disc type. The processes will now be described with reference to this flow chart. First, it is determined whether the U-TOC exists in Step F601. If the U-TOC exists, the process proceeds to Step F602, and then it is determined whether an identification code for the high-density MD format exists in the maker code area of the U-TOC. If the identification code does not exist in the U-TOC, the process proceeds to Step F606 and concludes that the loaded disc is the readable-writable MD. If the identification code exists in the U-TOC, the process proceeds to Step F605, and then it is determined whether the code “HiMD” for a high-density MD is written in the system ID of the P-TOC during reading the P-TOC. If the code exists, the process proceeds to Step F611 and concludes that the loaded disc is the high-density MD type B. On the contrary, if the code does not exist in the P-TOC, the process proceeds to Step F610 and concludes that the loaded disc is the high-density MD type A.

If the U-TOC does not exist in Step F601, it is determined whether the P-TOC exists in Step F603. If the P-TOC does not exist in this step, the process proceeds to Step F607 and concludes that the loaded disc is the high-density MD type C. If the P-TOC exists, the process proceeds to Step F604, and then it is determined whether the code “HiMD” for a high-density MD is written in the system ID of the P-TOC. If the code exists, the process proceeds to Step F609 and concludes that the loaded disc is the playback-only high-density MD. If the code does not exist in the P-TOC, the process proceeds to Step F608 and concludes that the loaded disc is the playback-only MD.

By the combining of the detection of the P-TOC and the U-TOC as the management information in the above-described processes, the types of the discs (the playback-only MD, the readable-writable MD, the high-density MD type A, the high-density MD type B, the playback-only high-density MD, and the high-density MD type C) can be determined.

8. Process for Determining Writability

Next, process for determining the information indicated by the detection holes H0 and H1 formed in the cartridge 91 of the disc 90, in particular, the setting of the writability, will now be described. As described above, the detection hole H0 is used for setting the writability for the playback-only MD, the readable-writable MD, and the high-density MD type A, and the detection hole H1 is used for setting the writability for the high-density MD type B, the playback-only high-density MD, and the high-density MD type C. Accordingly, in order to determine the writability of the disc 90 when the cartridge 91 is loaded in the reading-writing apparatus 1, the result of the determination of the disc type and the states of the detection holes H0 and H1 are required to be combined.

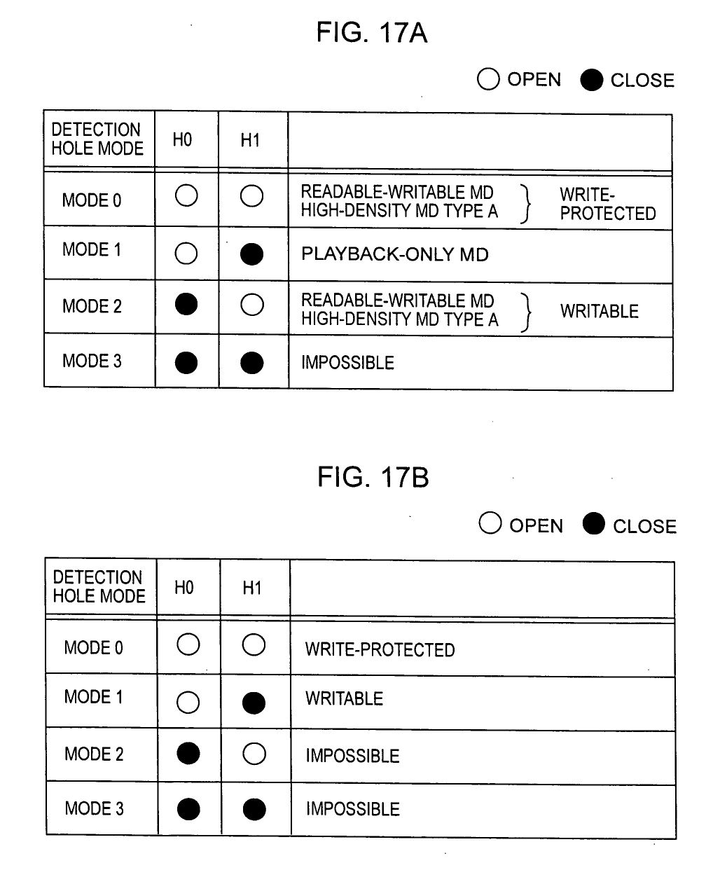

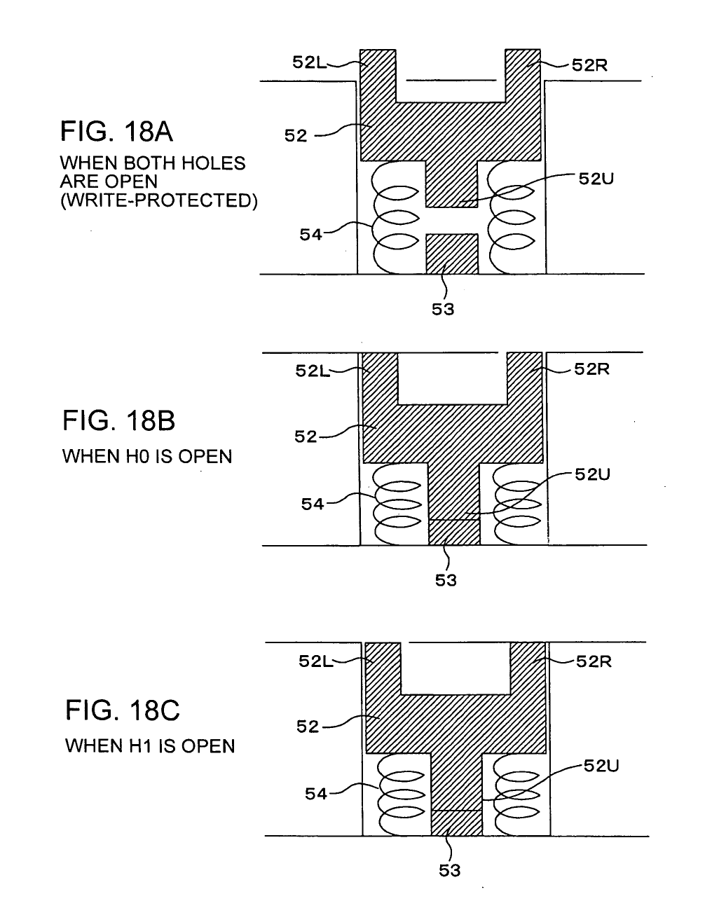

FIGS. 17A and 17B illustrate the states of the detection holes H0 and H1 represented by “mode”. FIGS. 18A to 18C illustrate the operations inside the hole-detecting unit 50 according to the states of the detection holes H0 and H1. FIG. 17A illustrates the modes for the playback-only MD, the readable-writable MD, and the high-density MD type A. In this case, the detection hole H0 is used for determining the writability, and the detection hole H1 is used for determining the reflectance. The states of the two detection holes are represented by Mode 0 to Mode 3, as shown in the drawing.

In Mode 0, both the detection holes H0 and H1 are open. FIG. 18A illustrates the operation inside the hole-detecting unit 50 for this case. Since the projections 52R and 52L are not pushed, the pushing element 52 does not move from the predetermined position. Therefore, the contact portion 52U is remote from the detecting switch 53 by a predetermined distance, i.e. the switch remains off. As a result, the readable-writable MD and the high-density MD type A are write-protected.

In Mode 1, the detection hole H0 is open, whereas the detection hole H1 is closed. This indicates the playback-only MD (write-protected). Accordingly, the disc is write-protected regardless of the state of the detecting switch 53.

In Mode 2, the detection hole H0 is closed, whereas the detection hole H1 is open. FIG. 18C illustrates the operation inside the hole-detecting unit 50 for this case. Since the projection 52R is pushed by the detection hole HO, the pushing element 52 moves downward from the predetermined position. Therefore, the contact portion 52U comes into contact with the detecting switch 53, i.e. the switch is turned on. As a result, the readable-writable MD and the high-density MD type A are writable.

In Mode 3, both the detection holes H0 and H1 are closed. As is clear from FIGS. 7 and 9, this mode is theoretically impossible.

FIG. 17B illustrates the modes for the high-density MD type B, the playback-only high-density MD, and the high-density MD type C. In this case, the detection hole H0 is always open, and the detection hole H1 is used for determining the writability. As in the case for FIG. 17A, the states of the detection holes H0 and H1 are also represented by Mode 0 to Mode 3.

In Mode 0, both the detection holes H0 and H1 are open. As shown in FIG. 18A, the projections 52R and 52L are not pushed, and thus the pushing element 52 does not move from the predetermined position. Therefore, the contact portion 52U is remote from the detecting switch 53 by a predetermined distance, i.e. the switch remains off. As a result, the high-density MD type B, and the high-density MD type C are write-protected. The mode of the playback-only high-density MD is always set to this Mode 0.

In Mode 1, the detection hole H0 is open, whereas the detection hole H1 is closed. As shown in FIG. 18B, the projection 52L is pushed by the detection hole H1, and thus the pushing element 52 moves downward from the predetermined position. Therefore, the contact portion 52U comes into contact with the detecting switch 53, i.e. the switch is turned on. As a result, the high-density MD type B and the high-density MD type C are writable.

In Mode 2, the detection hole H0 is closed, whereas the detection hole H1 is open. In Mode 3, both the detection holes H0 and H1 are closed. These modes are both theoretically impossible.

As described with reference to FIGS. 17A to 18C, the modes indicating the states of the detection holes H0 and H1 have different definitions depending on the disc types. Therefore, the writability can be determined from the detection holes after the determination of the disc type. In other words, only a single switch functioning as a detecting device can determine the writability. That is to say, the storage controller 32 can appropriately determine the writability of the disc 90 by the detecting signal from the hole-detecting unit 50 (on or off of the hole-detecting unit 50) having the structure shown in FIGS. 2A to 3B.

In the above-described embodiment, it is determined whether one of the two projections is pushed from the state of the switch in the hole-detecting unit 50. However, the determination may be carried out using a pushing element having a plurality of projections for a plurality of detection holes. It may be determined whether at least one of the plurality of projections is pushed or not from the state of the switch in a contact portion and a detecting switch. That is to say, since multiple pieces of information can be converted into one signal of on or off, the hole-detecting unit 50 in the above-described embodiment can be applied not only to disc drives but also to various apparatuses, for example apparatuses using an OR circuit.

9. Structures of Other Hole-Detecting Units

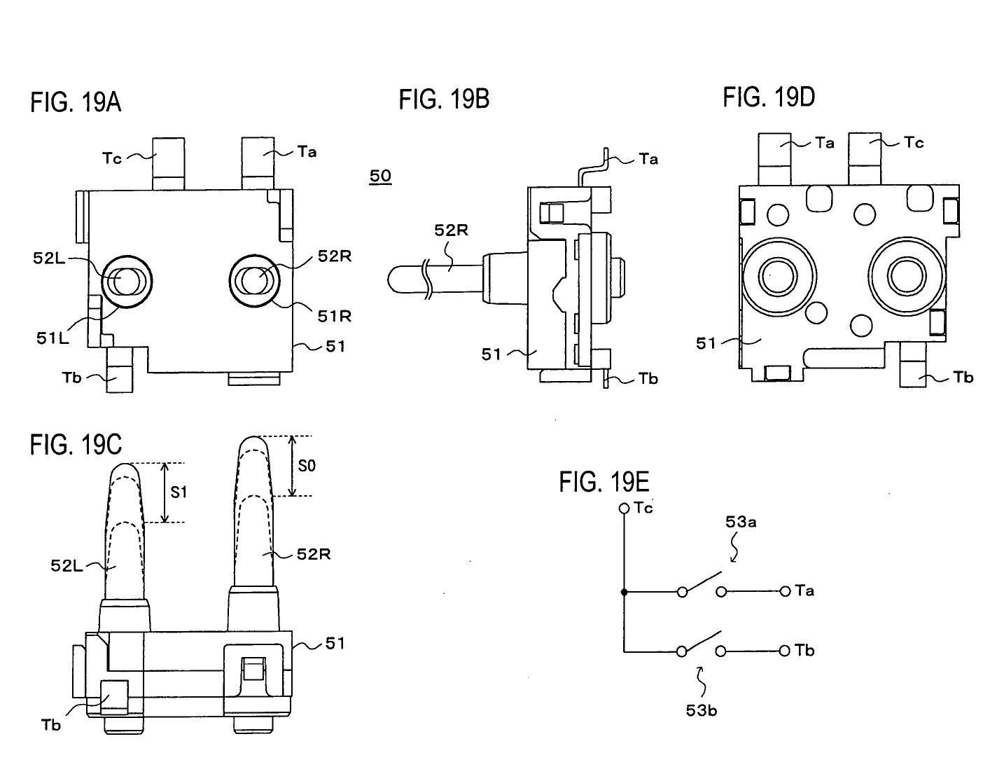

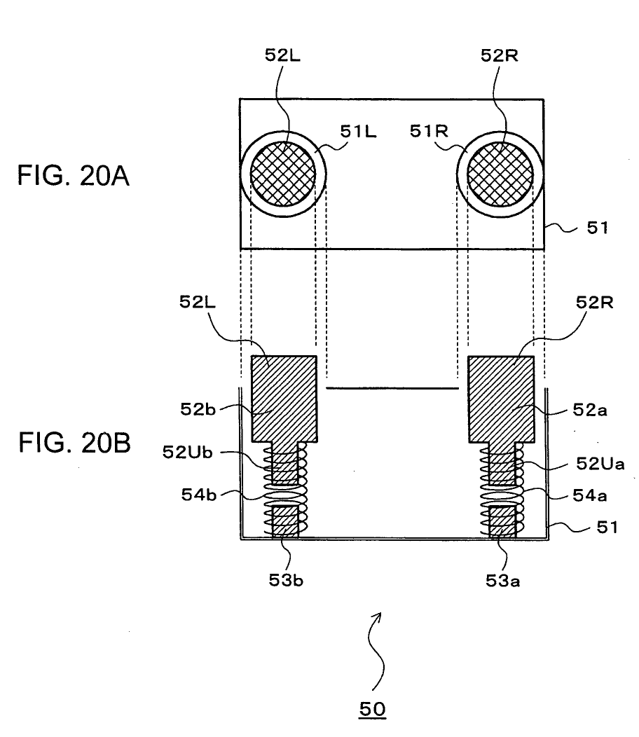

The hole-detecting unit 50 attached to the reading-writing apparatus 1 may have a structure shown in FIGS. 19A to 20B. FIGS. 19A, 19B, 19C, and 19D are a top view, a side view, a front view, and a bottom view of another example of the hole-detecting unit 50, respectively. FIG. 19E is a circuit diagram of the hole-detecting unit 50. FIGS. 20A and 20B are schematic views illustrating the inner structure of the hole-detecting unit 50 shown from the top and the side, respectively.

With reference to FIGS. 19A to 19E, the hole-detecting unit 50 has the similar structure as that shown in FIGS. 2A to 2D. The hole-detecting unit 50 includes a guide 51 as a casing, and projections 52R and 52L protruding from approximately circular holes 51R and 51L formed in the top face of the guide 51. With reference to FIGS. 20A and 20B, the guide 51 includes two pushing elements 52a and 52b, two detecting switches 53a and 53b, and two biasing elements 54a and 54b.

The top portion of the pushing element 52a is the projection 52R, and the bottom portion of the pushing element 52a is a contact portion 52Ua opposing the detecting switch 53a. The biasing element 54a such as a coiled spring is disposed under the pushing element 52a so as to support the pushing element 52a from the bottom. The pushing element 52a is retained at a standstill in the air, i.e. at a predetermined position where the projection 52R protrudes from the hole 51R to a highest position, by the biasing force of the biasing element 54a. At this time, the contact portion 52Ua of the pushing element 52a is remote from the detecting switch 53a by a predetermined distance. The same applies to the pushing element 52b.

The detecting switches 53a and 53b form the circuit shown in FIG. 19E. When the detecting switch 53a or 53b is brought into contact with or is pushed by the contact portion 52Ua or the contact portion 52Ub, i.e. the pushing element 52a or 52b moves downward from the predetermined position, the corresponding switch in the circuit shown in FIG. 19E is turned on. In contrast, when the contact portions 52Ua and 52Ub are remote from the detecting switches 53a and 53b by the predetermined distance, i.e. the pushing elements 52a and 52b are at the predetermined positions, the switches are turned off. In short, the pushing elements 52a and 52b turns on or off the detecting switches 53a and 53b functioning as independent switches in this structure. The detecting switches 53a and 53b include contact points respectively disposed on the top faces thereof for coming into contact with the contact portions 52Ua and 52Ub and are connected to terminals Ta, Tb, and Tc so as to form the circuit shown in FIG. 19E. The terminals Ta, Tb, and Tc are disposed outside the guide 51 as shown in FIG. 19A, and connected at the predetermined position of the printed board 64 shown in FIG. 1.

The writability of the disc 90 can be determined by this hole-detecting unit 50. That is to say, the storage controller 32, for example, may determine the above-described on state when any one of the detecting switches 53a and 53b is turned on from the signal of the terminals Ta, Tb, and Tc. In short, when any one of the switches is turned on, the disc is writable except for the playback-only MD. In this sense, the state of voltage at the terminals Ta and Tb using an OR circuit when a predetermined potential is applied to the terminal Tc in the circuit shown in FIG. 19E may be used as a signal for determining the writability by the storage controller 32. Also, the state of the voltage when the terminals Ta and Tb are connected may be used as the signal for determining the writability.

10. Setting of Protruding Length of Hole-Detecting Unit

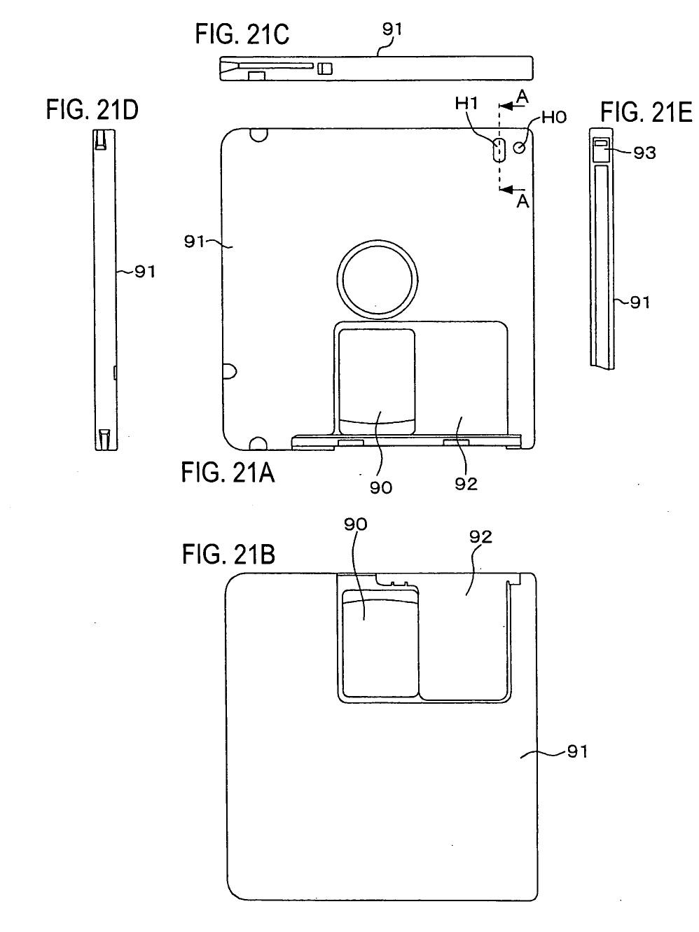

As shown in FIG. 2C or 19C, the lengths of the projections 52R and 52L in the hole-detecting unit 50 according to the embodiments are different. The reasons will be described with reference to FIGS. 21 to 24. First, the structures of the detection holes H0 and H1 of the disc according to this embodiment are described in detail. The disc in this case corresponds to the high-density MD type B or type C.

FIGS. 21A, 21B, 21C, 21D, and 21E are a bottom view, a top view, a rear view, a left side view, and a right side view of a disc cartridge, respectively. As described with reference to FIG. 10, the cartridge has the detection holes H0 and H1 at the predetermined position of the bottom face thereof as shown in FIG. 21A. Moreover, the cartridge has the slider 93 on the side face as shown in FIG. 21E, and the detection hole H1 can be opened or closed by operating this slider 93.

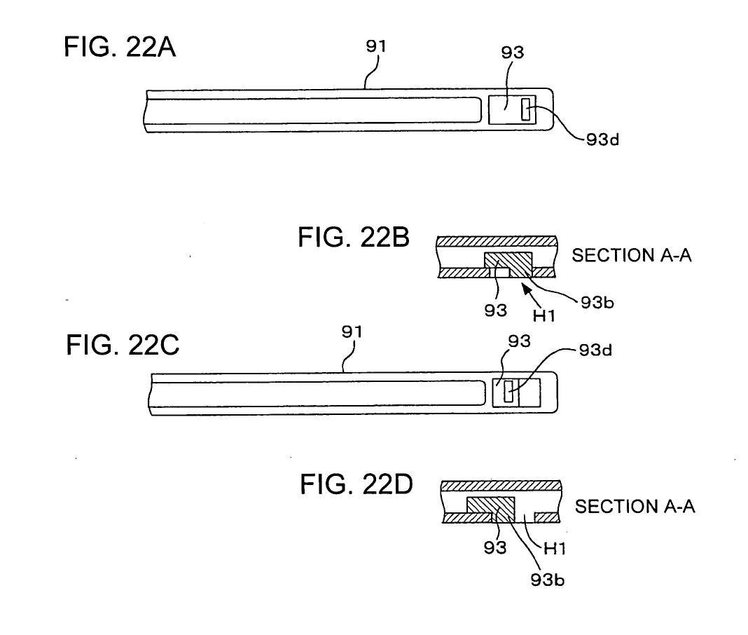

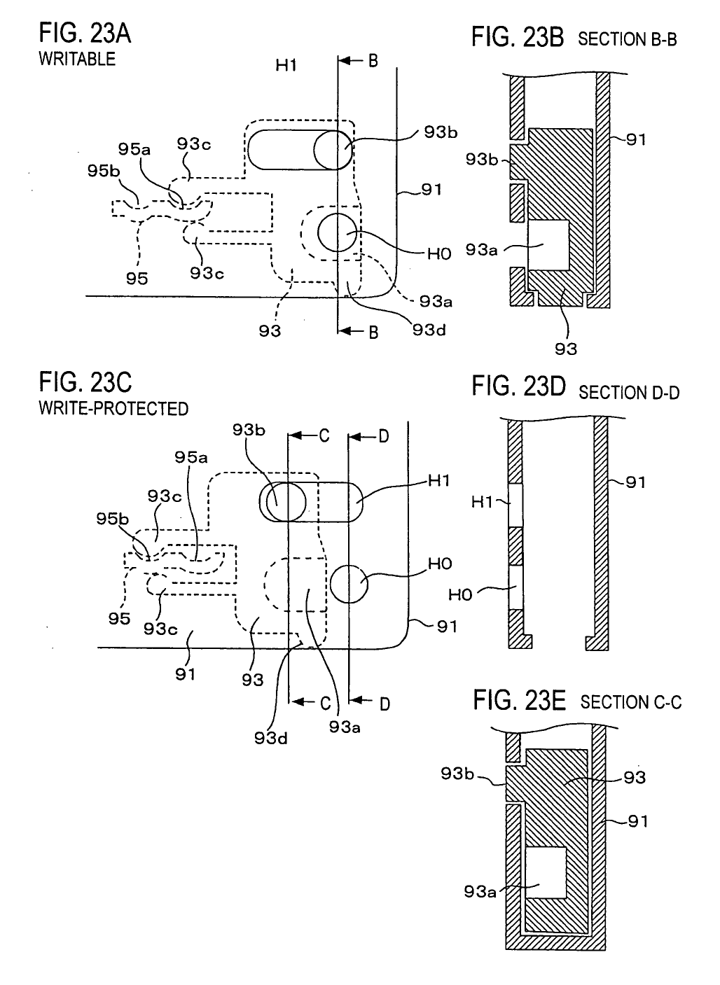

FIGS. 22A and 22C are the side views of the cartridge, and FIGS. 22B and 22D are cross-sectional views taken along line A-A in FIG. 21A. The detection hole H1 is closed in FIGS. 22A and 22B, whereas the detection hole H1 is opened in FIGS. 22C and 22D. FIG. 23A is an enlarged bottom view of a portion of the detection holes H0 and H1 of the cartridge 91 when the detection hole H1 is closed, and FIG. 23B is a cross-sectional view taken along line B-B in FIG. 23A. FIG. 23C is an enlarged bottom view of a portion of the detection holes H0 and H1 of the cartridge 91 when the detection hole H1 is opened, and FIGS. 23D and 23E are cross-sectional views taken along lines D-D and C-C in FIG. 23C, respectively.

With reference to the drawings, the slider 93 includes a hollow 93a formed at the position corresponding to the detection hole H0 in the thickness direction of the cartridge, a projection 93b protruding at the position corresponding to the detection hole H1 in the thickness direction of the cartridge, a locking portion 93c for maintaining the position of the slider 93 during opening or closing, and an operating projection 93d for sliding the slider 93.

Users can slide the slider 93 by operating the operating projection 93d as shown in FIGS. 22A and 22C. When the slider 93 is at the position shown in FIG. 22A, the locking portion 93c engages with a first curved portion 95a of an undulated rib 95 formed inside the cartridge as shown in FIG. 23A so as to maintain the position. When the slider 93 is at the position shown in FIG. 22C, the locking portion 93c engages with a second curved portion 95b of the undulated rib 95 as shown in FIG. 23C so as to maintain the position.

As is clear from FIGS. 23A, 23B, 23C, and 23E, the hollow 93a of the slider 93 is hollowed at the position corresponding to the detection hole H0 in the thickness direction, and is larger than the size of the detection hole H0. In other words, the projection 93b for opening and closing the detection hole H1 is thick, and the hollow 93a corresponding to the detection hole H0 is thin in the slider 93. As a result, as is clear from FIGS. 23A and 23C, the slider 93 does not close the detection hole H0 regardless of its position. Accordingly, the detection hole H0 always remains open.

As is clear from FIGS. 23A, 23B, 23C, and 23E, the projection 93b of the slider 93 is formed in a size and a shape at the position corresponding to the detection hole H1 so as to fit in the detection hole H1, which is a long hole. As shown in FIGS. 23A and 23C, the projection 93b is disposed inside the long hole regardless of the sliding position. The detection hole H1 in this embodiment is a long hole in which the projection 93b can slide. The detection hole H1 is at least a circular hole disposed in the predetermined position in the category of the MD system, and may be a hole formed at the right half position of the detection hole H1 shown in FIG. 23A. In short, the detection hole H1 is not always a long hole, and may have other shapes with appropriate opening-closing mechanisms. When the right half of the long hole is covered with the projection 93b as shown in FIG. 23A, the detection hole H1 is closed. When the projection 93b is not disposed at the right half of the long hole as shown in FIG. 23C, the detection hole H1 is opened. As shown in FIGS. 22B and 22D, the top face of the projection 93b of the slider 93 is disposed so as to form an approximately horizontal plane with respect to the bottom face of the cartridge 91.

As described above, the slider 93 always maintains the detection hole H0 open, and functions as a mechanism for opening and closing the detection hole H1. Furthermore, when the detection hole H1 is closed by the projection 93b, the plane with which the projection 52L of the hole-detecting unit 50 of the disc drive comes into contact is disposed so as to form an approximately horizontal plane (the appropriately same level in the thickness direction) with respect to the face of the cartridge 91.

The detection hole H0 is used in determining the writability of the first-generation MDs. Since the detection hole H0 is always open, the discs according to the embodiment are write-protected in old-type disc drives. The detection hole H1 can be opened or closed by users for setting the writability using the detection hole H1. By utilizing the detection hole H1 for setting the writability, which was originally used in detecting the reflectance of the readable-writable MD and the like, the discs according to the embodiment do not require a third detection hole especially for setting the writability. Accordingly, a disc drive compatible with these discs does not require an additional switch for the detection hole. Therefore, the apparatus can be reduced in size and thickness, or can be reduced in costs.

The reason why the projection 93b forms an approximately horizontal plane with respect to the face of the cartridge when the detection hole H1 is closed is as follows: As described above, the detection holes H0 and H1 are disposed at the predetermined positions on the discs. In the hole-detecting unit 50 of the disc drive, the projections 52R and 52L are formed at the positions corresponding to the detection holes H0 and H1, respectively. In the old-type disc drive, two independent switches are formed at positions corresponding to the detection holes H0 and H1.

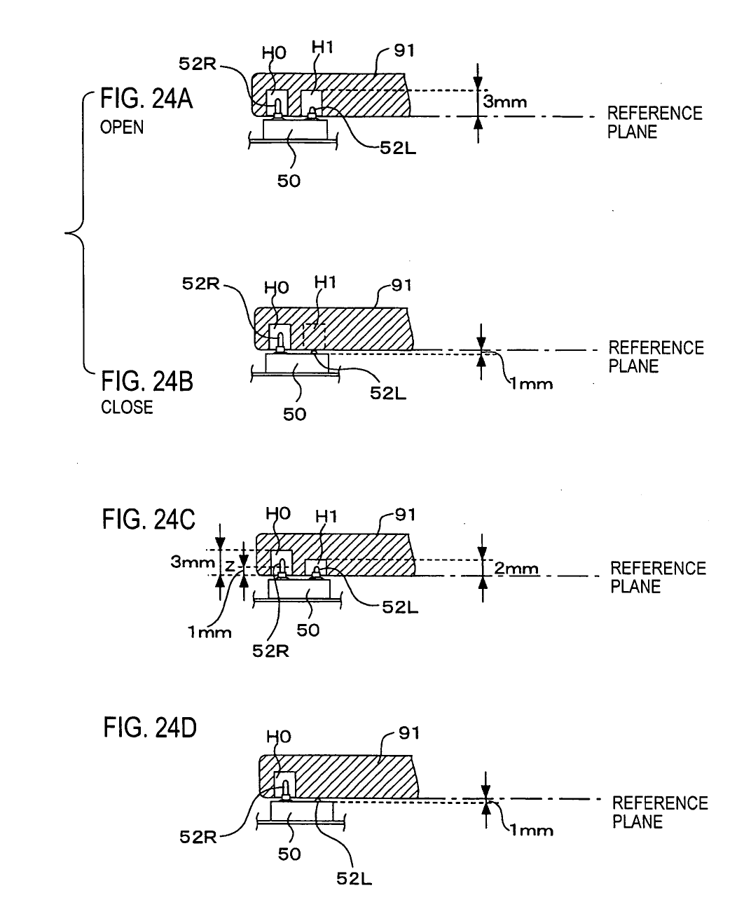

FIG. 24C illustrates the detection holes H0 and H1 and the respective projections 52R and 52L in the case for the readable-writable MD (and the high-density MD type A). FIG. 24D illustrates those in the case for the playback-only MD. The readable-writable MD shown in FIG. 24C includes both the detection holes H0 and H1, and the depth of the detection hole H0 in the thickness direction of the cartridge is approximately 3 mm. The detection hole H0 can be opened or closed by the slider 93. When the detection hole H0 is closed, the position of a part of the slider is approximately 1 mm lower than the bottom face of the cartridge 91 (a reference plane) shown by a dashed line Z. The length of 1 mm corresponds to the thickness of the cartridge 91. Unlike the high-density MD type B or type C, the readable-writable MD does not include the projection 93b in the slider 93. Accordingly, the detection hole H0 is “covered” with the slider at the position 1 mm lower than the reference plane. Thus, when the projection 52R is in contact with the part of the slider at the position 1 mm lower than the reference plane, the detection hole H0 is determined as closed (ON). In contrast, when the projection 52R is not in contact with the part of the slider at the position 1 mm lower than the reference plane as shown in the drawing, the detection hole H0 is determined as opened (OFF). Therefore, the designed moving range S0 of the projection 52R (the stroke for determining the open or close state) shown in FIGS. 2C and 19C is from a position approximately 1 mm lower than the reference plane to a position not reaching 3 mm (slightly more than 2 mm).

As shown in FIG. 24C, the depth of the other detection hole H1 of the readable-writable MD is, for example, approximately 2 mm from the reference plane. It is determined in view of the playback-only MD shown in FIG. 24D, and the detection hole H1, which is always open. As shown in FIG. 24D, the playback-only MD does not include detection hole H1. The detection hole H1 of the readable-writable MD is formed for indicating the difference in the reflectance between the readable-writable MD and the playback-only MD without the detection hole H1. Therefore, the projection 52L determines the state without the detection hole H1 as closed, and thus determines the state where the projection 52L is in contact with the bottom face of the cartridge 91 (reference plane) as shown in FIG. 24D as closed (ON). On the other hand, the state where the projection 52L is not in contact with the reference plane as shown in FIG. 24C is determined as opened (OFF). Therefore, the designed moving range Si of the projection 52L (the stroke for determining the open or close state) is from the position of the reference plane to a position not reaching 2 mm (slightly more than 1 mm) from the reference plane. From the same reason, in the old-type disc drives compatible with the MDs, the switch corresponding to the detection hole H0 protrudes longer in the thickness direction of the cartridge than that corresponding to the detection hole H1 during the off state although the strokes are the same.

Here, consider that the detection hole H1 is used in determining the writability and is opened or closed by the slider 93 as in the case for the high-density MD type B and the high-density MD type C. When the slider 93 does not have the projection 93b as in the case for, for example, the readable-writable MD, the switch is in contact with the slider at the position 1 mm lower than the reference plane while the detection hole H1 is closed. However, the position is an approximate midpoint of the moving range of the switch for the detection hole H1 of the old-type disc drive, and causes the wrong determination of the on or off state when the high-density MD type B or type C is loaded in the old-type disc drive in consideration of various production errors. For the disc drive compatible with the high-density MD type B and the high-density MD type C according to the embodiment (for example, the storage unit 2 shown in FIG. 2), if the designed moving range of the projection 52L for the detection hole H1 is from the position 1 mm lower than the reference plane to the position not reaching 3 mm as in the case for the projection 52R, the determination of the on or off state can be properly conducted. However, when the playback-only MD is loaded in the disc drive according to the embodiment, the projection 52L is pushed against the bottom face of the cartridge 91 (reference plane) since the detection hole H1 does not exist. In this case, the projection 52L is pushed over the designed range in the ON direction, and the switch structure may be damaged by the pushing element 52 (or the projection 52L).

Thus, for the high-density MD type B and the high-density MD type C, the projection 93b is formed on the slider 93 so as to form an approximate horizontal plane with respect to the reference plane when the detection hole H1 is opened. FIGS. 24A and 24B illustrate the open state and the closed state of the detection hole H1 in the high-density MD type B and the high-density MD type C, respectively. When the projection 52L is in contact with the approximate horizontal plane of the reference plane, i.e. the projection 93b, as shown in FIG. 24B, the state is determined as closed (ON), and when the projection 52L is not in contact with the reference plane as shown in FIG. 24A, the state is determined as opened (OFF).

Accordingly, also in the case for the high-density MD type B and the high-density MD type C, the designed moving range S0 of the projection 52R is preferably from the position approximately 1 mm lower than the reference plane to the position not reaching 3 mm (a slightly more than 2 mm), and the designed moving range S1 of the projection 52L is preferably from the position of the reference plane to the position not reaching 2 mm (a slightly more than 1 mm). As described above, in the hole-detecting unit 50 according to the embodiment, the projection 52R protrudes longer than the projection 52L since the projections 52R and 52L can appropriately work for any one of the playback-only MD, the readable-writable MD, the high-density MDs types A, B, and C.

The technical scope of the present invention is not limited to the above embodiments, and various modifications are permissible. In addition, although the reading-writing apparatus in this specification is compatible with discs of the MD system, the present invention is also applicable to disc drives compatible with recording media in cartridge discs in other categories.

1. A writing apparatus comprising:
a body for loading a recording medium;
a detecting device having first and second projections inside the body; and
a controller for determining the type of the recording medium loaded in the body on the basis of the states of the first and the second projections of the detecting device and for performing a process depending on the type of the recording medium.

2. The writing apparatus according to claim 1, wherein
the controller performs a predetermined process to the recording medium when the first or the second projection is pushed.

3. The writing apparatus according to claim 1, wherein
the controller determines the type of the recording medium loaded in the body on the basis of the states of the first and the second projections of the detecting device; and
the controller determines the recording medium as writable when the first or the second projection is pushed.

4. The writing apparatus according to claim 1,
wherein the body comprises
a mechanical deck having first and second holes from which the first and the second projections protrude;
wherein the detecting device comprises
a detecting switch disposed on the bottom face of the body;
a pushing element having an approximate Y-shape formed of the first and the second projections and a contact portion for coming into contact with the detecting switch; and
a biasing element for biasing the pushing element to a predetermined position such that the first and the second projections protrude from the first and the second holes;
wherein the contact portion is separate from the detecting switch when the pushing element is at the predetermined position, and the contact portion is in contact with the detecting switch when the first or the second projection of the pushing element is pushed by the loaded recording medium; and
wherein the controller determines the type of the recording medium on the basis of the contact state of the contact portion and the detecting switch, and performs the process depending on the type of the recording medium.

5. The writing apparatus according to claim 4, wherein
the controller determines the writability of the loaded recording medium on the basis of the contact state of the contact portion and the detecting switch.

6. The writing apparatus according to claim 1, wherein
the controller determines the type of the recording medium of the loaded recording medium on the basis of a signal based on a light beam reflected from the loaded recording medium and the states of the first and the second projections, and performs the process depending on the type of the recording medium.

7. A detecting device for detecting the on-off state of a switch, comprising:
a supporting body having a plurality of holes;
a detecting switch disposed at a predetermined position inside the supporting body;
a pushing element including a plurality of projections protruding from the respective holes and a contact portion for coming into contact with the detecting switch; and
a biasing element for biasing the pushing element to a predetermined position such that the projections protrude from the respective holes, wherein
the contact portion is separate from the detecting switch when the pushing element is at the predetermined position, and the contact portion is in contact with the detecting switch when at least one of the projections of the pushing element is pushed.

8. The detecting device according to claim 7, wherein the protruding lengths of the projections differ from each other.
